(19) United States
(12) Patent Application Publication
(10) Pub. No.: US 2024/0369507 A1
(43) Pub. Date: Nov. 7, 2024

(54) ANION SENSING USING 1,2,3-TRIAZOLATE METAL-ORGANIC FRAMEWORK NANOPARTICLES

(71) Applicant: University of Oregon, Eugene, OR (US)

(72) Inventors: Carl Brozek, Eugene, OR (US); Jiawei Huang, Eugene, OR (US)

(73) Assignee: University of Oregon, Eugene, OR (US)

(21) Appl. No.: 18/653,828

(22) Filed: May 2, 2024

Related U.S. Application Data
(60) Provisional application No. 63/463,837, filed on May 3, 2023.

(51) Int. Cl. G01N 27/30; C07F 11/00; C07F 15/02

(52) U.S. Cl. CPC G01N 27/30; C07F 11/005; C07F 15/025

(57) ABSTRACT

Disclosed herein are aspects of a method for sensing anions using 1,2,3-triazolate metal-organic frameworks (MOFs). In certain aspects, the method exposes an electrochemical anion sensor to a sample, wherein the electrochemical anion sensor comprises an electrode functionalized with a conductive porous film comprising a plurality of crystalline metal organic framework (MOF) nanoparticles, and a potential is applied to the electrode. Also disclosed herein are aspects of an electrochemical analyte sensor comprising a working electrode functionalized with a plurality of MOF nanoparticles, a counter electrode, and a reference electrode.

### CROSS REFERENCE TO RELATED APPLICATION

This application claims the benefit of and priority to the earlier filing date of U.S. Provisional Patent Application No. 63/463,837, filed on May 3, 2023, the entirety of which is incorporated herein by reference.

### ACKNOWLEDGMENT OF GOVERNMENT SUPPORT

This invention was made with government support under Contract No. 2114430 awarded by the National Science Foundation. The government has certain rights in the invention.

### FIELD

The present disclosure concerns a method for sensing anions using 1,2,3-triazolate metal-organic frameworks (MOFs), and sensors for performing the method.

### BACKGROUND

Supramolecular ion receptors that selectively sense anions have numerous applications in the biological, environmental, and technological sectors. Metal-organic frameworks (MOFs) are one of the many types of supramolecular receptors that have gained considerable scientific interest. The positively charged metal nodes in MOFs require counter anions for maintaining charge neutrality, which could enable trapping target anions within MOF pores via liquid-to-solid extraction. However, the sluggish mass transport of anions restricts the types of MOFs that can be utilized to capture target anions. Additionally, optical properties of MOFs, such as fluorescence or luminescence, are commonly employed to investigate the sensing capability of MOFs, which limits their reuse and further inhibits the ability to differentiate among multiple anions in the solution.

There is a need in the art for news methods of sensing anions by using MOF nanoparticles with structural stability in both organic and aqueous media and which can improve sensing kinetics in comparison to their bulk material alternatives.

### SUMMARY

Disclosed herein is a method, comprising: exposing an electrochemical anion sensor to a sample, wherein the electrochemical anion sensor comprises an electrode functionalized with a conductive porous film comprising a plurality of crystalline metal organic framework (MOF) nanoparticles having a pore size ranging from greater than 4.5 Å to less than 10 Å; and applying a potential to the electrode.

An electrochemical analyte sensor is also disclosed herein, the electrochemical analyte sensor comprising (i) a working electrode functionalized with a plurality of crystalline metal-organic framework (MOF) nanoparticles having a pore size ranging from greater than 4.5 Å to less than 10 Å; (ii) a counter electrode; and (iii) a reference electrode.

Also disclosed herein is method of using the electrochemical analyte sensor, comprising exposing the electrochemical analyte sensor to a liquid sample; and applying a varying potential between the working electrode and the counter electrode.

The foregoing and other objects, features, and advantages of the present disclosure will become more apparent from the following detailed description, which proceeds with reference to the accompanying figures.

### BRIEF DESCRIPTION OF THE DRAWINGS

FIG. 1A shows a crystal structure of a MOF material comprising a secondary building unit (SBU) cluster.

FIG. 1B shows the pore structure of a MOF nanocrystal.

FIG. 1C is a schematic illustrating the pores of a reduced chromium 1,2,3-triazolate (Cr(TA)₂) MOF nanocrystal prior to oxidation-induced intercalation.

FIG. 1D is a schematic illustrating the pores of an oxidized Cr(TA)₂ MOF nanocrystal after oxidation-induced intercalation comprising a solvated BF₄_{^{−}} anion and a desolvated CF₃SO₃_{^{−}} anion.

FIG. 2A is the cyclic voltammogram (CV) of anion-intercalation-induced redox chemistry of the Cr(TA)₂ pores of an electrochemical sensor comprising Cr(TA)₂ nanoparticles.

FIG. 2B is a graph showing the PXRD patterns and the Rietveld refinement fittings for Cr(TA)₂.

FIG. 2C is an SEM image of a 25-nm Cr(TA)₂ MOF nanocrystal.

FIG. 2D is a graph showing the PXRD patterns and the Rietveld refinement fittings for an iron 1,2,3-triazolate (Fe(TA)₂) material.

FIG. 2E is an SEM image of a 17-nm Fe(TA)₂ MOF nanocrystal.

FIG. 3A shows the cyclic voltammogram of an electrochemical sensor comprising Cr(TA)₂ nanoparticles in the presence of trace amounts of ClO₄_{^{−}} anions.

FIG. 3B shows the cyclic voltammogram of an electrochemical sensor comprising Cr(TA)₂ nanoparticles in the presence of both ClO₄_{^{−}} and BF₄_{^{−}} anions.

FIG. 3C shows the cyclic voltammogram of an electrochemical sensor comprising Cr(TA)₂ nanoparticles in the presence of trace amounts of Cl⁻ anions.

FIG. 4A is the cyclic voltammogram of an electrochemical sensor comprising Cr(TA)₂ nanoparticles in a 0.1 M KOTf water electrolyte.

FIG. 4B shows the E_{1/2} of OTf⁻ intercalation redox feature in multiple CV scans of an electrochemical sensor comprising Cr(TA)₂ nanoparticles.

FIG. 4C shows the current density of OTf⁻ intercalation redox feature in multiple CV scans of an electrochemical sensor comprising Cr(TA)₂ nanoparticles.

FIG. 5A is the cyclic voltammogram of an electrochemical sensor comprising Cr(TA)₂ nanoparticles in 0.1 M TBAOTf/water electrolyte.

FIG. 5B shows the current density of OTf⁻ intercalation redox feature in multiple CV scans of an electrochemical sensor comprising Cr(TA)₂ nanoparticles.

FIGS. 6A-6B show the cyclic voltammograms of an electrochemical sensor comprising Cr(TA)₂ nanoparticles in the presence of trace amounts of ClO₄_{^{−}} anions.

FIG. 6C is the linear relationship between E_{1/2} on intercalation feature and the concentration of ClO₄_{^{−}} anions using an electrochemical sensor comprising Cr(TA)₂ nanoparticles.

FIGS. 6D-6E show the cyclic voltammograms of an electrochemical sensor comprising Cr(TA)₂ nanoparticles in the presence of trace amounts of Cl⁻ anions.

FIG. 6F shows the linear relationship between current density on intercalation feature and the concentration of Cl⁻ anions using an electrochemical sensor comprising Cr(TA)₂ nanoparticles.

FIGS. 6G-6H show the cyclic voltammograms of an electrochemical sensor comprising Cr(TA)₂ nanoparticles in the presence of trace amounts of Br⁻ anions.

FIG. 6I shows the linear relationship between current density on intercalation feature and the concentration of Br⁻ anions using an electrochemical sensor comprising Cr(TA)₂ nanoparticles.

FIGS. 6J-6K show the cyclic voltammograms of an electrochemical sensor comprising Cr(TA)₂ nanoparticles in the presence of trace amounts of I⁻ anions.

FIG. 6L shows the linear relationship between current density on intercalation feature and the concentration of I⁻ anions using an electrochemical sensor comprising Cr(TA)₂ nanoparticles.

FIG. 7A shows the cyclic voltammogram obtained from comparing the Fe(TA)₂ intercalation process and the Cr(TA)₂ intercalation process, wherein (i) the Fe(TA)₂ intercalation process exhibits a pre-wave in the potential range of ca. 1.0 V-1.2 V vs Fc^{0/+} and a sharp peak and (ii) the Cr(TA)₂ intercalation process exhibits a sharp feature at ca. −0.6 V vs Fc^{0/+}, thus demonstrating that BF₄_{^{−}} anions intercalate without complete desolvation in the Cr(TA)₂ nanoparticles.

FIG. 7B shows the mass change vs. charge change in the anodic scan direction of the electrochemical sensor comprising Cr(TA)₂ nanoparticles during the cyclic voltammogram measurements for FIG. 7A.

FIG. 7C shows the mass change vs. charge change in the anodic scan direction of the electrochemical sensor comprising Fe(TA)₂ nanoparticles during the cyclic voltammogram measurements for FIG. 7A.

FIG. 7D is a schematic illustrating the pore structures inside a Fe(TA)₂ material, calculated using the spin-polarized density functional theory (DFT) and demonstrating a distance of 11.5 Å between C-C and 3.4 Å between H-H.

FIG. 7E shows the plot of log(j) vs log(scan rate) for −0.6 redox feature of the electrochemical sensor comprising Cr(TA)₂ nanoparticles at varying scan rates.

FIG. 7F shows the plot of log(j) vs log(scan rate) for −1.0 redox feature of the electrochemical sensor comprising Cr(TA)₂ nanoparticles at varying scan rates.

FIG. 7G shows the electrochemical quartz crystal microbalance (EQCM) of the cyclic voltammogram (solid lines) and the mass charge (dotted lines) of the electrochemical sensor comprising Cr(TA)₂ nanoparticles in TBABF₄ acetonitrile electrolyte at a 10-mV/s scan rate.

FIG. 7H shows the CV-trace-dependent mass-to-charge ratio and the corresponding apparent molecular mass during the conditioning period of the electrochemical sensor comprising Cr(TA)₂ nanoparticles (insert showing the conditioning CV traces of the electrochemical sensor comprising Cr(TA)₂ nanoparticles in the potential region of BF₄_{^{−}}-intercalation-induced redox feature).

FIG. 7I shows the trace-dependent CV of the electrochemical sensor comprising Fe(TA)₂ nanoparticles in 0.1-M TBABF₄ acetonitrile electrolyte, wherein the CV traces were collected at a 10-mV/s scan rate.

FIG. 7J shows the j-V measurement of the electrochemical sensor comprising Fe(TA)₂ nanoparticles in 0.1-M TBACl acetonitrile electrolyte and demonstrating an increase in current density when the applied potential is larger than ca. 0.9 V vs. Fc^{0/+}.

FIG. 8A is a graph showing the DFT calculations for determining the activation barrier at the initial state (IS), transition state (TS), and final state (FS), demonstrating an activation barrier of 0.54 for the BF₄_{^{−}} transport between pores of Cr(TA)₂.

FIG. 8B shows the Raman spectra of the electrochemical sensor comprising Cr(TA)₂ nanoparticles and the electrochemical sensor comprising Fe(TA)₂ nanoparticles before incorporating into an electrochemical cell, wherein the vibrational feature highlighted originates from the triazolate linkers of Cr(TA)₂ and Fe(TA)₂ nanocrystals.

FIG. 8C shows the reversibility test of vₗᵢₙₖₑᵣ for the electrochemical sensor comprising Cr(TA)₂ nanoparticles under reductive and oxidative applied potentials.

FIG. 8D shows the variable potential vₗᵢₙₖₑᵣ shift in the potential region corresponding to intercalation redox chemistry inside the Cr(TA)₂ pores.

FIG. 8E shows the variable potential vₗᵢₙₖₑᵣ shift in the potential region corresponding to intercalation redox chemistry inside the Fe(TA)₂ pores.

FIG. 9A shows the cyclic voltammetry of the electrochemical sensor comprising Cr(TA)₂ nanoparticles in the presence of anions BF₄_{^{−}}, ClO₄_{^{−}}, PF₆_{^{−}}, and OTf⁻.

FIG. 9B shows the anion intercalation redox feature of the electrochemical sensor comprising Cr(TA)₂ nanoparticles.

FIG. 9C shows the plot of anion-dependent log(j) vs log(scan rate) for the −0.6 redox feature of the electrochemical sensor comprising Cr(TA)₂ nanoparticles in TBABF₄_{^{−}}.

FIG. 9D shows the plot of anion-dependent log(j) vs log(scan rate) for the −0.4 redox feature of the electrochemical sensor comprising Cr(TA)₂ nanoparticles in TBAClO₄_{^{−}}.

FIG. 9E shows the plot of anion-dependent log(j) vs log(scan rate) for the −0.2 redox feature of the electrochemical sensor comprising Cr(TA)₂ nanoparticles in TBAPF₆.

FIG. 9F shows the plot of anion-dependent log(j) vs log(scan rate) for the −0.1 redox feature of the electrochemical sensor comprising Cr(TA)₂ nanoparticles in TBAOTf.

FIG. 10A shows the mass-to-charge ratio at the intercalation redox event with BF₄_{^{−}} into the Cr(TA)₂ nanoparticles of the electrochemical sensor and demonstrating a Δm/ΔQ of 1.2 and n=0.7.

FIG. 10B shows the mass-to-charge ratio at the intercalation redox event with ClO₄_{^{−}} into a Cr(TA)₂ film and demonstrating a Δm/ΔQ of 1.3 and n=0.6.

FIG. 10C shows the mass-to-charge ratio at the intercalation redox event with PF₆_{^{−}} into into the Cr(TA)₂ nanoparticles of the electrochemical sensor and demonstrating a Δm/ΔQ of 1.3 and n=0.4.

FIG. 10D shows the mass-to-charge ratio at the intercalation redox event with OTf⁻ into the Cr(TA)₂ nanoparticles of the electrochemical sensor and demonstrating a Δm/ΔQ of 1.0 and n=less than 0.

FIG. 10E shows the mass change of the electrochemical sensor comprising Cr(TA)₂ nanoparticles in the potential region of intercalation redox with BF₄_{^{−}}.

FIG. 10F shows the mass change of the electrochemical sensor comprising Cr(TA)₂ nanoparticles in the potential region of intercalation redox with ClO₄_{^{−}}.

FIG. 10G shows the mass change of the electrochemical sensor comprising Cr(TA)₂ nanoparticles in the potential region of intercalation redox with PF₆_{^{−}}.

FIG. 10H shows the mass change of the electrochemical sensor comprising Cr(TA)₂ nanoparticles in the potential region of intercalation redox with OTf⁻.

FIG. 10I shows the scan-rate-dependent ΔE value for the intercalation redox feature of the electrochemical sensor comprising Cr(TA)₂ nanoparticles in 0.1 M TBAOTf and 0.1 M TBABF₄.

FIG. 11A is a graph showing the DFT studies into transport barrier of BF₄_{^{−}}, ClO₄_{^{−}}, PF₆_{^{−}}, and OTf⁻ inside the Cr(TA)₂ pores.

FIG. 11B is a graph showing the DFT calculations for determining the activation barrier of ClO₄_{^{−}} intercalation inside Cr(TA)₂ nanoconfined pores for the initial state (IS), transition state (TS), and final state (FS); demonstrating an activation barrier of ca. 0.60 eV.

FIG. 11C is a graph showing the DFT calculations for determining the activation barrier of PF₆_{^{−}} intercalation inside Cr(TA)₂ nanoconfined pores for the initial state (IS), transition state (TS), and final state (FS); demonstrating an activation barrier of ca. 0.83 eV.

FIG. 11D is a graph showing the DFT calculations for determining the activation barrier of OTf⁻ intercalation inside Cr(TA)₂ nanoconfined pores for the initial state (IS), transition state (TS), and final state (FS); demonstrating an activation barrier of ca. 0.81 eV.

FIG. 12A is a graph showing the CV measurements of a of the electrochemical sensor comprising Cr(TA)₂ nanoparticles during the titration of TBABF₄ into a 0.1-M TBAOTf/acetonitrile electrolyte.

FIG. 12B is a graph showing the E_{1/2} of the BF₄_{^{−}}-intercalation-induced redox feature of the electrochemical sensor comprising Cr(TA)₂ nanoparticles with different BF₄_{^{−}} titration amounts into a 0.1-M TBAOTf/acetonitrile electrolyte.

FIG. 12C is a graph showing the E_{1/2} of the OTf⁻-intercalation-induced redox feature of the electrochemical sensor comprising Cr(TA)₂ nanoparticles with different BF₄_{^{−}} titration amounts into a 0.1-M TBAOTf/acetonitrile electrolyte.

FIG. 12D is a graph showing the CV measurements of the electrochemical sensor comprising Cr(TA)₂ nanoparticles during titrating TBAOTf into a 0.1-M TBABF₄/acetonitrile electrolyte.

FIG. 12E is a graph showing the CV measurements of the electrochemical sensor comprising Cr(TA)₂ nanoparticles during titrating both TBABF₄ and TBAClO₄ into a 0.1-M TBAOTf/acetonitrile electrolyte.

FIG. 12F is a graph showing the CV measurements of the electrochemical sensor comprising Cr(TA)₂ nanoparticles during titrating TBAClO₄ into a 0.1-M NaBArF₄/acetonitrile electrolyte.

FIG. 12G is a graph showing the CV measurements of the electrochemical sensor comprising Cr(TA)₂ nanoparticles during the titration of TBAClO₄ into a 0.1-M TBAOTf/acetonitrile electrolyte.

FIG. 13A is a schematic showing the pore structures inside Cr(TA)₂ calculated using the spin-polarized density functional theory (DFT); demonstrating a distance of 12.1 Å between C-C and 3.8 Å between H-H.

FIG. 13B is a graph showing the CV measurements of the electrochemical sensor comprising Cr(TA)₂ nanoparticles during titrating TBAClO₄ into a 0.1-M NaBArF₄/acetonitrile electrolyte.

FIG. 14A is a graph showing the CV measurements of the electrochemical sensor comprising Cr(TA)₂ nanoparticles measured by titrating different amounts of TBAClO₄ in the nM scale into 0.1-M TBAOTf/acetonitrile electrolyte.

FIG. 14B is a graph showing the reusability test results of using of the electrochemical sensor comprising Cr(TA)₂ nanoparticles for electrochemical ClO₄_{^{−}} sensing, wherein CV measurements were conducted in OTf⁻-intercalation-induced redox feature in Cr(TA)₂ film with different ClO₄_{^{−}} titration amounts into a 0.1-M TBAOTf acetonitrile electrolyte; and after the addition of ClO₄_{^{−}}, the potential of −1.5 V vs Fc^{0/+} is applied to Cr(TA)₂ nanoparticle film for 20 minutes and E_{1/2} of intercalation redox feature of Cr(TA)₂ film is re-measured in clean 0.1-M TBAOTf acetonitrile electrolyte.

FIG. 14C is a graph showing the structural stability test of the electrochemical sensor comprising Cr(TA)₂ nanoparticles in water via multiple CV measurement cycles.

FIG. 14D is a graph showing the trace-dependent E_{1/2} of the intercalation redox feature, and trace-dependent current density of the intercalation and de-intercalation redox feature of the electrochemical sensor comprising Cr(TA)₂ nanoparticles.

FIG. 14E is a graph showing the multiple traces of CV measurement of the electrochemical sensor comprising Cr(TA)₂ nanoparticles in 0.1 M KOTf water electrolyte at the scan rate of 10 mV/s.

FIG. 14F is a graph showing the trace-dependent E_{1/2} of intercalation redox feature using the electrochemical sensor comprising Cr(TA)₂ nanoparticles.

FIG. 14G is a graph showing the trace-dependent current density of intercalation and de-intercalation redox feature using the electrochemical sensor comprising Cr(TA)₂ nanoparticles.

FIG. 14H is a graph showing the CV measurements for sensing of ClO₄_{^{−}} anions of the electrochemical sensor comprising Cr(TA)₂ nanoparticles in aqueous electrolyte.

FIG. 14I shows the cyclic voltammogram cycle of the variation of E_{1/2} for the intercalation redox feature during titrations of KClO₄ into a 0.1-M KOTf aqueous electrolyte using the of the electrochemical sensor comprising Cr(TA)₂ nanoparticles.

### DETAILED DESCRIPTION

### 1. Overview of Terms

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements unless the context clearly indicates otherwise.

The methods described herein should not be construed as limiting in any way. Instead, the present disclosure is directed toward all novel and non-obvious features and aspects of the present disclosure, alone and in various combinations and sub-combinations with one another. The disclosed methods are not limited to any specific aspect or feature or combinations thereof, nor do the disclosed methods require that any one or more specific advantages be present or problems be solved. Any theories of operation are to facilitate explanation, but the methods are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed devices and methods can be used in conjunction with other devices and methods. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. Furthermore, examples may be described with reference to directions indicated as “above,” “below,” “upper,” “lower,” and the like. These terms are used for convenient description, but do not imply any particular spatial orientation unless so indicated.

In some examples, values, procedures, or devices may be referred to as “lowest,” “best,” “minimum,” or the like. It will be appreciated that such descriptions are intended to indicate that a selection among many used functional alternatives can be made, and such selections need not be better, smaller, or otherwise preferable to other selections.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing aspects from discussed prior art, the numbers are not approximates unless the word “about” is recited. Furthermore, not all alternatives recited herein are equivalents.

To facilitate review of the various aspects of the disclosure, the following explanations of specific terms are provided. Any functional group disclosed herein and/or defined below can be substituted or unsubstituted, unless otherwise indicated herein.

Aliphatic: A hydrocarbon group having at least one carbon atom to 50 carbon atoms (C₁₋₅₀), such as one to 25 carbon atoms (C₁₋₂₅), or one to ten carbon atoms (C₁₋₁₀), and which includes alkanes (or alkyl), alkenes (or alkenyl), alkynes (or alkynyl), including cyclic versions thereof, and further including straight- and branched-chain arrangements, and all stereo and position isomers as well.

Aromatic: A cyclic, conjugated group or moiety of, unless specified otherwise, from 5 to 15 ring atoms having a single ring (e.g., phenyl) or multiple condensed rings in which at least one ring is aromatic (e.g., naphthyl, indolyl, or pyrazolopyridinyl); that is, at least one ring, and optionally multiple condensed rings, have a continuous, delocalized π-electron system. Typically, the number of out of plane π-electrons corresponds to the Hückel rule (4n+2). The point of attachment to the parent structure typically is through an aromatic portion of the condensed ring system. For example,

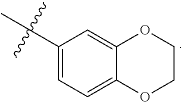 [SMILES: *c1ccc2c(c1)OCCO2]

However, in certain examples, context or express disclosure may indicate that the point of attachment is through a non-aromatic portion of the condensed ring system. For example,

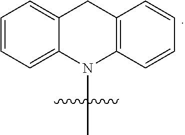 [SMILES: *N1c2ccccc2Cc2ccccc21]

An aromatic group or moiety may comprise only carbon atoms in the ring, such as in an aryl group or moiety, or it may comprise one or more ring carbon atoms and one or more ring heteroatoms comprising a lone pair of electrons (e.g., S, O, N, P, or Si), such as in a heteroaryl group or moiety. Aromatic groups may be substituted with one or more groups other than hydrogen, such as aliphatic, heteroaliphatic, haloaliphatic, haloheteroaliphatic, aromatic, or an organic functional group.

Bulk Material: A material comprising a plurality of particles, wherein a majority of the particles have an average size above 300 nm in all dimensions. Bulk materials have different chemical and physical properties compared to the MOF nanoparticles disclosed herein. A bulk material typically comprises a majority of particles that are visible to the naked eye and bulk materials typically exhibit particle sizes in a very large range, often exhibiting polydispersity index values above 0.3.

Coordination Complex: A structure comprising a central atom (or ion), typically a metal component (or ion thereof) as described herein, and one or more surrounding ligand components, such as a 1,2,3-triazolate ligand as described herein, that are coordinated with the central atom (or ion). In particular aspects, the ligand component and the central atom or ion can be coordinated through a coordinate covalent bond, wherein the ligand component binds the central atom or ion through one or more lone pairs; or the ligand component and the central atom or ion can be coordinated through a covalent bond, wherein the ligand component and central atom or ion bind one another by each providing a single electron to the other component.

Halide: A fluoride anion (F⁻), chloride anion (Cl⁻), bromide anion (Br⁻), iodide anion (I⁻), or an astatide (At⁻) anion.

Halogen (or Halo): A fluoro, chloro, bromo, or iodo substituent or a substituent that is an astatine atom.

Haloaliphatic: An aliphatic group wherein one or more hydrogen atoms, such as one to 10 hydrogen atoms, independently is replaced with a halogen atom, such as fluoro, bromo, chloro, or iodo.

Haloheteroaliphatic: A heteroaliphatic group wherein one or more hydrogen atoms, such as one to 10 hydrogen atoms, independently is replaced with a halogen atom, such as fluoro, bromo, chloro, or iodo.

Heteroaliphatic: An aliphatic group comprising at least one heteroatom to 20 heteroatoms, such as one to 15 heteroatoms, or one to 5 heteroatoms, which can be selected from, but not limited to oxygen, nitrogen, sulfur, silicon, boron, selenium, phosphorous, and oxidized forms thereof within the group. Alkoxy, ether, amino, disulfide, peroxy, and thioether groups are exemplary (but non-limiting) examples of heteroaliphatic. In some embodiments, a fluorophore can also be described herein as a heteroaliphatic group, such as when the heteroaliphatic group is a heterocyclic group.

Intercalation: Refers to the inclusion or insertion of one or more anions in the pores of crystalline metal-organic framework (MOF) nanoparticles.

Metal-Organic Framework (MOF): A material comprising at least one metal component (or ion thereof) coordinated to a 1,2,3-triazolate ligand according to the present disclosure to provide a three-dimensional structure. In particular aspects of the disclosure, the MOF comprises chromium as the metal component.

Nitrile: A chemical functional group having a formula —C≡N.

Nanoparticle: A nano-sized particle having an average size ranging from 1 nm to 200 nm in all directions. Nanoparticles of the present disclosure are not visible to the naked eye.

Organic Functional Group: A functional group that may be provided by any combination of aliphatic, heteroaliphatic, aromatic, haloaliphatic, and/or haloheteroaliphatic groups, or that may be selected from, but not limited to, aldehyde; aroxy; halogen; nitro; cyano; azide; carboxyl (or carboxylate); amide; ketone; carbonate; imine; azo; carbamate; hydroxyl; thiol; sulfonyl (or sulfonate); oxime; ester; thiocyanate; thioketone; thiocarboxylic acid; thioester; dithiocarboxylic acid or ester; phosphonate; phosphate; sulfate; nitrate; silyl ether; sulfinyl; thial; or combinations thereof.

Oxyanion: An anion comprising at least one oxygen atom and one other element.

Perhalogenated: An anion comprising a plurality of halogens such as, but not limited to, BF₄_{^{−}}, PF₆_{^{−}}, OTf⁻, CF₃SO₃_{^{−}}, or CF₃SO₂NH⁻.

### II. Introduction

The ability to sense the presence of and/or identify anions can have an impact in numerous applications in the biological, environmental, and technological sectors. While MOF materials comprise positively charged metal nodes that require counter anions for maintaining charge neutrality and thus would appear to be a useful tool in trapping of target anions, the sluggish mass transport of anions in such systems restricts the types of MOFs that can be utilized to capture target anions. Additionally, optical properties of MOFs, such as fluorescence or luminescence, are commonly employed to investigate the sensing capability of MOFs, which limits their reuse and lacks the ability to differentiate multiple anions in the solution.

The present disclosure includes a novel method for anion sensing using 1,2,3-triazolate metal-organic frameworks (MOFs) nanoparticles. In certain aspects, the MOF nanoparticles can vary in diameter from several to hundreds of nanometers to provide for improved ion transport in comparison to their bulk alternatives. Moreover, the MOF nanoparticles have improved structural stability in both organic and aqueous media. In some aspects, the MOF nanoparticles are Cr(TA)₂ MOF nanocrystals, wherein “TA” is 1,2,3-triazolate. Moreover, in some aspects, the crystal structure may comprise a 1,2,3-triazolate ring for selective anion sensing. By controlling the applied voltage, the anion intercalation (positive potential) and de-intercalation (negative potential) processes can be manipulated inside the MOF pores to make the MOF nanoparticles, such as Cr(TA)₂, reusable in anion sensing. Meanwhile, different anions possess distinct intercalation barriers and therefore require different energy inputs (i.e., the applied voltage) to drive ion transportation into Cr(TA)₂ pores, opening the capability of sensing multiple types of anions in solutions at the same time.

### III. Method

Aspects of the present disclosure are directed to a method for anion sensing using a MOF nanoparticle comprising a coordination complex. In some aspects, the method comprises exposing an electrochemical anion sensor to a sample, wherein the electrochemical anion sensor comprises an electrode functionalized with a conductive porous film comprising a plurality of crystalline metal organic framework (MOF) nanoparticles and applying a potential to the electrode. In certain aspects, the method can further comprise measuring a signal produced by one or more anions present in the sample to thereby detect the presence and/or identity of the one or more anions. In some aspects of the present disclosure, the method comprises adjusting an applied voltage to manipulate anion intercalation (positive potential) and de-intercalation (negative potential) processes inside the MOF pores to make a reusable MOF nanoparticle for anion sensing.

In particular aspects disclosed herein, the sample comprises one or more anions that independently have a diameter ranging from greater than 0 Å to 10 Å, such as from 1 Å to 10 Å, 2 Å to 10 Å, 3 Å to 10 Å, 4 Å to 10 Å, 5 Å to 10 Å, 6 Å to 10 Å, 7 Å to 10 Å, 8 Å to 10 Å, or 9 Å to 10 Å.

In some aspects, the anions that can be detected using the method according to the present disclosure are independently selected from oxyanions, nitrile-containing anions, halide anions, perhalogenated anions, or any combination thereof. In some aspects, combinations of any such anions can be detected. In certain aspects, the oxyanion is a halogenated oxyanion (e.g., ClO₄_{^{−}}), a sulfate, a phosphate, or a nitrate. In one example, the oxyanion is ClO₄_{^{−}}. In some aspects, the anion can be a nitrile-containing anion. In some such aspects, the nitrile-containing anion is dicyanamide (C₂N₃_{^{−}}). In certain aspects, the anion can be a halide anion such as, but not limited to, F⁻, I⁻, Cl⁻, or Br⁻. In some aspects, the anion can be a perhalogenated anion. In some examples, the perhalogenated anion is, but is not limited to, BF₄_{^{−}}, PF₆_{^{−}}, OTf⁻, or CF₃SO₂NH⁻.

In aspects disclosed herein, the method may comprise measuring a signal produced by one or more anions present in the sample to thereby detect the presence and/or identity of the one or more anions. In certain aspects, the one or more anions can comprise a mixture of a first anion species and a second ion species, and wherein the first anion species is different from the second anion species. In yet additional aspects, mixtures of first and second anion species can further comprise a third anion species, wherein the third anion species is different from the first anion species and the second anion species. The method can be used to detect the presence of each of the first, second, and third anion species and also can be used to determine the identity of each anion species.

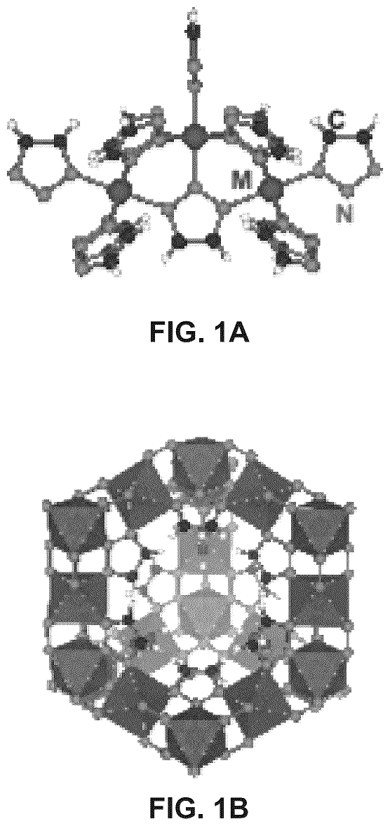

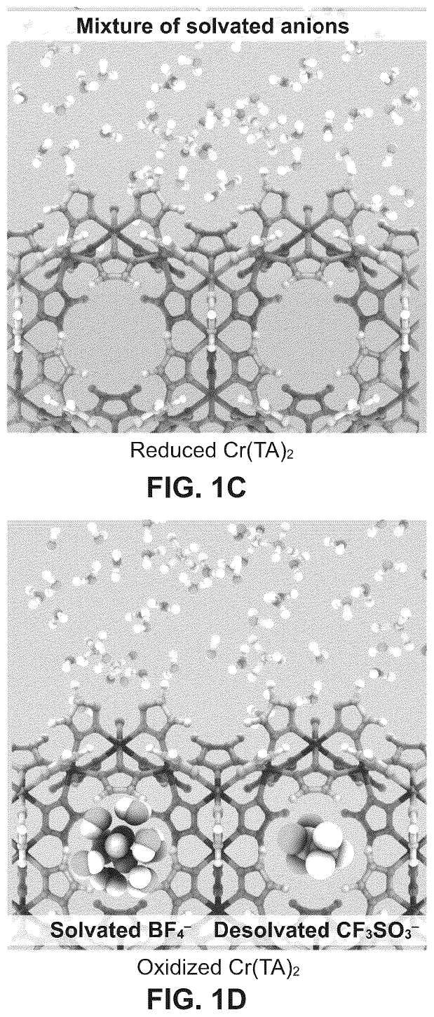

In certain aspects, conductive films comprising a plurality of MOF nanoparticles detect one or more anions in sample as distinct, reversible, and reproducible signals such as, but not limited to volumetric signals. In some aspects, the MOF nanoparticle may comprise a second building unit (SBU) cluster of MOF(TA)₂ as illustrated in FIG. 1A. Moreover, FIG. 1B is a schematic illustrating a MOF(TA)₂ pore structure. In preferable aspects, the plurality of MOF nanoparticles comprises Cr(TA)₂ and conductive films comprising a plurality of such Cr(TA)₂ nanoparticles can operate under aqueous conditions and repeated cycling. Without being bound by a theory of operation, the sensing mechanism involves a redox-coupled anion intercalation process sensitive to anion size, desolvation, and redox intercalation thermodynamics.

In some aspects, the method can detect amounts of one or more anions in a sample, wherein each of the anions in the sample can have a concentration ranging from 1 nanomolar (nM) to 1 molar (M), such as from 1 nM to 100000000 nM, 1 nM to 10000000 nM, 1 nM to 1000000 nM, 1 nM to 100000 nM, 1 nM to 10000 nM, 1 nM to 1000 nM, 1 nM to 500 nM, 1 nM to 400 nM, 1 nM to 300 nM, 1 nM to 200 nM, 1 nM to 100 nM, or 1 nM to 50 nM.

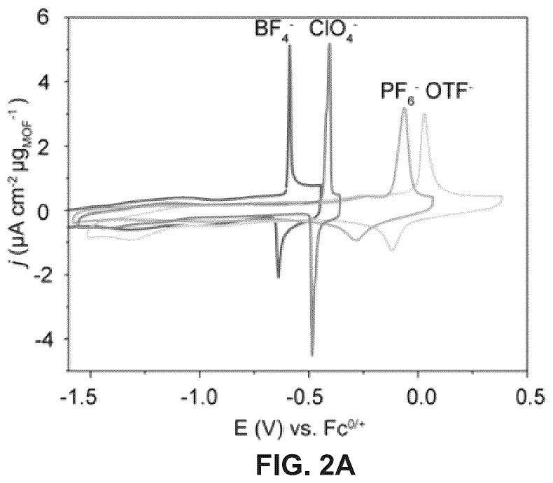

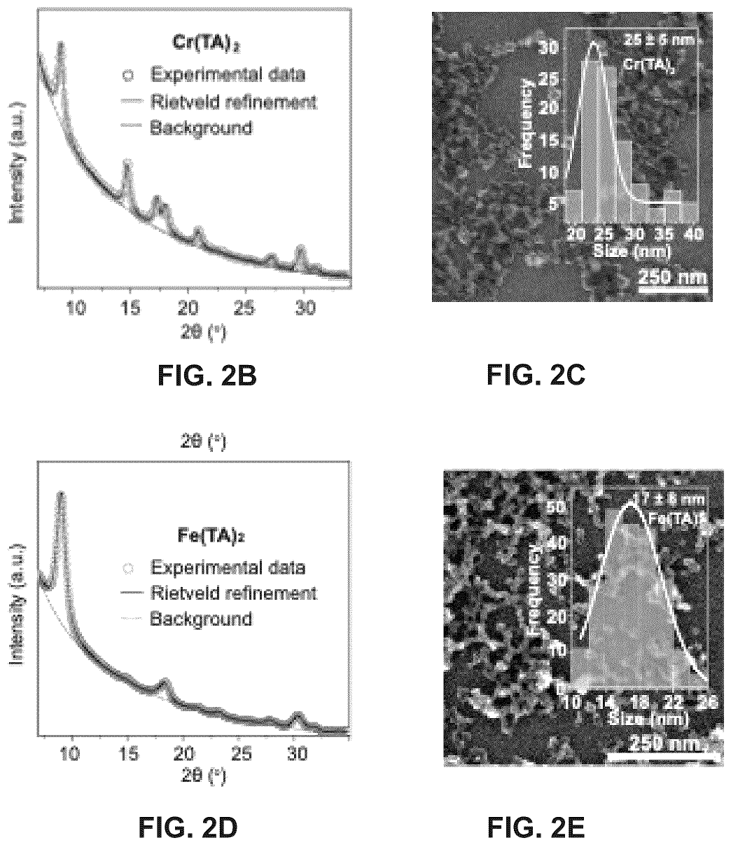

In certain aspects of the method, the electrode is functionalized with a layer or film comprising a plurality of the crystalline MOF nanoparticles described herein. An oxidation reaction can take place at the MOF-functionalized electrode, followed by the intercalation of the one or more anions into pores of the MOF nanoparticles. FIG. 1C is a schematic illustrating the pores of a reduced MOF nanocrystal comprising Cr(TA)₂ prior to oxidation-induced intercalation. FIG. 1D is a schematic illustrating the pores of an oxidized MOF nanocrystal comprising Cr(TA)₂ after oxidation-induced intercalation, wherein the presence of one or more anions such as, but not limited to, solvated BF₄_{^{−}} and/or desolvated CF₃SO₃_{^{−}} are detected by analyzing the intercalation redox feature. In certain aspects, the cyclic voltammogram (CV) of anion-intercalation-induced redox chemistry inside Cr(TA)₂ pores can be used to detect the presence of the one or more anions. For example, FIG. 2A is a CV of anion-intercalation-induced redox chemistry inside Cr(TA)₂ pores for detecting the presence and/or identifying one or more anions such as, but not limited to, BF₄_{^{−}}, ClO₄_{^{−}}, PF₆_{^{−}}, and OTf⁻.

In some aspects, the method may further comprise applying a negative voltage to de-intercalate the one or more anions from the pores of the MOF nanoparticles. In certain aspects, the electrode functionalized with the one or MOF nanoparticles can be reused by applying the negative voltage and de-intercalating the one or more anions from the pores of the MOF nanoparticles.

The MOF nanoparticles used in the methods disclosed herein comprise a metal component and a ligand component. In particular aspects, the ligand component of the MOF nanoparticles comprises a 1,2,3-triazolate ring and the metal component is chromium. The MOF nanoparticles are crystalline in form. In some aspects, the 1,2,3-triazolate ring can be substituted on one or both carbon atoms of the ring. In some such aspects, the substituent on the carbon atom(s) can be selected from an aliphatic group, an aromatic group, a heteroaliphatic group, a haloaliphatic group, a haloheteroaliphatic group, or an organic functional group. In representative aspects, the MOF nanoparticles comprise an MOF network comprising a plurality of chromium-1,2,3-triazolate coordination complexes. The metal-ligand coordination complexes typically comprise at least one chemical bond (e.g., at least one covalent or coordinate covalent) formed between the metal component and the ligand component. In some aspects, the metal-ligand coordination complexes comprise a plurality of metal components that are chemically bound to two or more ligand components, such as three ligand components, four ligand components, five ligand components, or six ligand components. In exemplary non-limiting aspect, the MOF nanoparticle may comprise Cr(TA)₂. In independent aspects, the crystalline metal organic (MOF) nanoparticles do not include Fe(TA)₂ nanoparticles. Examples included herein that use such MOF nanoparticles are used solely as comparative compounds and are not intended to be included within the scope of the present disclosure.

MOF nanoparticles of the present disclosure can have average sizes ranging from 4 nm to 150 nm, such as 4.5 nm to 150 nm, or 5 nm to 130 nm, or 5.5 nm to 130 nm. In particular disclosed aspects, the MOF nanoparticle size is determined as a crystallite size using Scherrer analysis, such as by using Equation 1.

$$τ = \frac{K λ}{β cos θ} \qquad Equation 1$$

With reference to Equation 1, t is the crystallite size, K is the shape factor (set at 1 for aspects calculated herein), λ is the source X-ray wavelength (Cu Ka, 0.154 nm), β is the full width at half max in radians, and θ is the half of the peak position in radians. For particles larger than 10 nm, size is additionally determined by scanning electron microscopy, a measurement that will typically give a larger value than that determined by Scherrer analysis from the same particle batch.

MOF nanoparticles disclosed herein typically comprise a crystal structure. The crystalline MOF nanoparticle aspects comprise crystals with any suitable morphology, such as spherical crystals, rod-like crystals, octahedral crystals, triangular crystals, and other shapes. In representative aspects, the MOF nanoparticles have a spherical, octahedral, or truncated octahedral shape. In independent aspects, the MOF nanoparticles are not amorphous or are not in powder form and thus are distinct from bulk materials. The MOF nanoparticles comprise pores that can have controlled sizes. In particular aspects disclosed herein, the pores can have sizes ranging from greater than 0 Å to 10 Å, such as from 1 Å to 10 Å, 2 Å to 10 Å, 3 Å to 10 Å, 4 Å to 10 Å, 5 Å to 10 Å, 6 Å to 10 Å, 7 Å to 10 Å, 8 Å to 10 Å, 9 Å to 10 Å. In preferable aspects, the MOF nanoparticles have a pore size ranging from at least 4.5 Å to 10 Å, such as 4.5 Å, 5 Å, 5.5 Å, 6 Å, 6.5 Å, 7 Å, 7.5 Å, 8 Å, 8.5 Å, 9 Å, or 9.5 Å. In certain aspects, the crystalline metal organic (MOF) nanoparticles are Cr(TA)₂ nanoparticles. In such aspects, the Cr(TA)₂ nanoparticles typically have a pore size ranging from greater than 4.5 Å to less than 10 Å. In aspects comparing pore size of Cr(TA)₂ nanoparticles with any Fe(TA)₂ particles, a pore size of 4.5 Å for the Cr(TA)₂ nanoparticles is not an approximation.

Also disclosed herein are aspects of a porous film made with the compositions comprising MOF nanoparticles of the present disclosure. The film can be a free-standing film, or it can be coupled with a substrate. The film can be uniform and have a smooth surface and/or can be conductive. Such film aspects can be used to make devices, such as MOF-based electrochemical devices, composite-based devices, and the like. In particular aspects, the film is made using any suitable technique, such as drop-casting, spin-coating deposition, printing, dipping, doctor blading, and the like. In particular aspects, the film is a free-standing film formed by dispersing a suspension comprising the MOF nanoparticles at a liquid-air interface and allowing any solvent of the suspension to evaporate or another drying technique. In other aspects, the film can be deposited onto a metal substrate, such as an electrode, a wafer, or other type of metal substrate. In some aspects, a suspension of the MOF nanoparticles is provided onto a substrate using a doctor blading technique. In particular disclosed aspects, the film can have a thickness ranging from 10 nm to 20 mm. The films exhibit good conductivity, with particular aspects providing conductivity values that are more than three times higher than conductivity values observed for a film formed from the corresponding bulk material. In particular aspects disclosed herein, the MOF nanoparticles can be used to provide films exhibiting conductivity values ranging from 1.0×10⁻¹⁰ S/cm to 1.0 S/cm, such as 1.0×10⁻⁷ S/cm to 1.0×10⁻³ S/cm, or 1.0×10⁻⁶ S/cm to 9.0×10⁻⁵ S/cm.

### IV. Electrochemical Analyte Sensor

The present disclosure also describes an electrochemical sensor for implementing the methods discussed herein. In certain aspects, the electrochemical sensor comprises a working electrode functionalized with a plurality of crystalline metal-organic framework (MOF) nanoparticles; a counter electrode; and a reference electrode. In some aspects, the working electrode is functionalized with a layer or film comprising the plurality of crystalline MOF nanoparticles. In such aspects, functionalization can comprise physical modification and/or chemical modification of the working electrode with the MOF nanoparticles.

In some aspects, the electrochemical analyte sensor may comprise a counter electrode and/or a reference electrode. In particular aspects, the counter electrode and/or reference electrode can comprise a metal. In certain aspects, the counter electrode can comprise platinum, gold, silver, platinum-iridium alloy, iridium, titanium, titanium alloy, stainless steel, cobalt alloy, and the like. In aspects disclosed herein the electrochemical sensor can comprise a reference electrode that comprises a metal selected from, but not limited to, silver and other similar metals (e.g. Ag/AgCl, and the like). In some aspects, the counter electrode and/or reference electrode can be in the form of a wire, rod, cylinder, tube, scroll, sheet, and the like.

In some aspects, the electrochemical sensor can further comprise a control unit comprising (i) a power component for applying an electrical potential to the working electrode; and/or (ii) a measuring component for measuring a voltage and/or a current. In some aspects, the power component is selected from a power supply, a voltage supply, a potentiostat, or any combination thereof. In aspects disclosed herein, the measuring component is selected from a voltmeter, a potentiometer, an ammeter, a resistometer, or any combination thereof.

In particular aspects disclosed herein, the electrochemical analyte sensor may comprise an electrolyte-containing solution comprising an organic solution or an aqueous solution. In certain aspects, the electrolyte-containing solution comprises, but is not limited to, a solution comprising a cationic group, such as metal cations (e.g., Li+, Na+, K⁺, Rb⁺, Cs⁺, Ca²⁺, Mg²+, Sr²⁺, or Ba²⁺), or organic cations (e.g., ammonium, sulfonium, imidazolium cations, and the like). In exemplary aspects, the solution is a TBA⁺-containing electrolyte and acetonitrile. In some aspects, the aqueous solution comprises a K⁺-containing electrolyte.

In certain aspects, the electrochemical sensor can be exposed to a liquid sample comprising one or more anions and a potential can be applied between the working electrode and the counter electrode. Detection of one or more anions can take place at the working electrode, which is where an oxidation and/or reduction reaction of interest occurs. In certain aspects, the counter electrode can provide and/or accumulate the electrons used in the electrochemical reaction at the working electrode. In some aspects, a reference electrode provides a reference potential for the system, specifically the electric potential at which the working electrode is biased in reference to the reference electrode.

In certain aspects, the potential can be a varying potential. The varying potential can establish a time-varying controlled potential relationship. In certain aspects, the varying potential can be detected as an intercalation potential. The varying potential can establish a time-varying controlled potential relationship between the working and reference electrode. In other aspects, the potential can be a fixed potential. In certain aspects, the fixed potential can be detected as a change in current. The fixed potential can establish a fixed controlled potential relationship between the working electrode and the reference electrode.

### V. Method of Making MOF Nanoparticles

Disclosed herein are aspects of a method for making MOF nanoparticles. In some aspects, the method comprises, consists essentially of, or consists of combining a metal precursor, a ligand precursor, a modulator component, and a solvent to provide a reaction mixture; stirring the reaction mixture at a suitable vortex speed for a period of time (e.g., at least 1 hour); and heating the reaction mixture at a temperature ranging from 80° C. to 140° C., such as 100° C. to 130° C., or 110° C. to 120° C. In some aspects, the method can further comprise cooling the reaction mixture to ambient temperature, centrifugating the reaction mixture, and washing the resulting MOF nanoparticles using a washing and filtering process. In particular aspects, washing can comprise filtering the MOF nanoparticles and using additional amounts of the solvent to wash away impurities. In independent aspects, the method does not require multiphase synthesis or dropwise reagent addition techniques typically used in the field of nanoparticle synthesis. In some aspects, the method can be carried out in a flow reactor, which can be a batch-wise flow reactor or a continuous flow reactor. In some aspects, the flow reactor can be a microfluidic flow reactor, a mesofluidic flow reactor, or a microfluidic or mesofluidic reactor in parallel and/or under continuous flow to produce large-scale amounts of the nanoparticles (e.g., up to a ton scale size).

The metal precursor used in aspects of the method disclosed herein can include chromium halides, such as chromium chlorides; chromium nitrates; chromium triflates; chromium tetrafluoroborates; chromium oxides; or combinations thereof. In particular aspects, the metal precursor is chromium(II) trifluoromethanesulfonate. The ligand precursor typically is a triazole compound, such as a 1,2,3-triazole. In some aspects, the 1,2,3-triazole can be substituted on one or both carbon atoms of the ring. In some such aspects, the substituent on the carbon atom(s) can be selected from an aliphatic group, an aromatic group, a heteroaliphatic group, a haloaliphatic group, a haloheteroaliphatic group, or an organic functional group. In an independent aspect, the 1,2,3-triazole is not bis(1H-1,2,3-triazolo[4,5-b],[4′,5′-i])dibenzo[1,4]dioxin. In particular aspects, the ligand precursor is 1,2,3-triazole with no substituents on the carbon atoms of the triazole ring. The modulator component can be as described herein.

In particular aspects, the method comprises, consists essentially of, or consists of combining a chromium-containing precursor (e.g., a chromium salt, such as a chromium halide or chromium(II) trifluoromethanesulfonate), 1,2,3-triazole, 1-methylimidazole, and dimethylformamide to provide a reaction mixture; stirring the reaction mixture at a suitable vortex speed for a period of time (e.g., at least 1 hour); and heating the reaction mixture at a temperature ranging from 80° C. to 140° C., such as 100° C. to 130° C., or 110° C. to 120° C. Suitable vortex speeds can range from 100 rpm to 1,500 rpm, such as 500 rpm to 1,000 rpm, or 700 rpm to 900 rpm.

In particular aspects, the modulator component is used in an amount ranging from 0.05 equivalents to 11 equivalents (relative to the amount of metal component used), such as 0.055 equivalents to 10 equivalents, or 0.1 equivalents to 8 equivalents, or 1 equivalent to 5 equivalents. In particular aspects, the amount of the modulator component can be selected from 0.055 equivalents, 0.109 equivalents, 0.218 equivalents, 0.436 equivalents, 0.709 equivalents, 3 equivalents, and 10.9 equivalents. The amount of the modulator component can be adjusted according to the desired size of the MOF nanoparticles. In particular aspects, higher equivalents of the modulator component, relative to the metal component, can facilitate obtaining smaller-sized MOF nanoparticles. In other aspects, lower equivalents of the modulator component, relative to the metal component, can facilitate obtaining larger-sized MOF nanoparticles. In yet other aspects, selecting a particular modulator component can be another way to tune MOF nanoparticle size. In some such aspects, modulator components that act as weak ligands (e.g., 5-bromo-1-methylimidazole) with respect to the metal component, can provide larger MOF nanoparticles.

In some aspects, the method can further comprise characterizing an isolated MOF nanoparticle to quantify the isolated MOF's nanoparticle's core diameter, determine how the MOF's nanoparticle's size is influenced by reaction conditions (such as the pH of the MOF nanoparticle precursor composition), or to determine the shape of the MOF nanoparticle. Techniques for characterizing the MOF nanoparticle can include, but are not limited to, SEM, Acid digestion ¹H NMR spectra, Scherrer analysis. Beer's Law plots can be used to determine nanoparticle/formula unit extinction coefficients, which can then be used to back-calculate nanoparticle concentration. Electrochemical data of MOF nanoparticle can be performed by CV scans. In some aspects, Scherrer analysis can be performed to determine the size of the MOF nanoparticles. Analysis can be conducted on a solution of MOF nanoparticles and/or an isolated MOF nanoparticle and can provide the ability to analyze and characterize nanoparticle size immediately, or substantially immediately, after the MOF nanoparticles are made. In some aspects, SEM images can also be used to determine polydispersity of the MOF nanoparticles.

### VI. Overview of Several Aspects

Disclosed herein are aspects of a method comprising exposing an electrochemical anion sensor to a sample, wherein the electrochemical anion sensor comprises an electrode functionalized with a conductive porous film comprising a plurality of crystalline metal organic framework (MOF) nanoparticles having a pore size ranging from greater than 4.5 Å to less than 10 Å; and applying a potential to the electrode.

In some aspects of the present disclosure, the method further comprises measuring a signal produced by one or more anions present in the sample to thereby detect the presence and/or identity of the one or more anions.

In any or all of the above aspects, the one or more anions independently have a diameter ranging from 1 Å to 10 Å.

In any or all of the above aspects, the one or more anions are independently selected from halide anions, perhalogenated anions, oxyanions, nitrile-containing anions, or any combination thereof.

In any or all of the above aspects, the one or more halide anions are selected from F⁻, Cl⁻, I⁻, Br⁻, or any combination thereof.

In any or all of the above aspects, the one or more perhalogenated anions are selected from BF₄_{^{−}}, PF₆_{^{−}}, OTf⁻, CF₃SO₃_{^{−}}, CF₃SO₂NH⁻, or any combination thereof.

In any or all of the above aspects, the one or more nitrile-containing anions are C₂N₃_{^{−}}.

In any or all of the above aspects, the one or more oxyanions comprise a halogen, sulfate, phosphate, or nitrate.

In any or all of the above aspects, the one or more oxyanions are ClO₄_{^{−}}.

In any or all of the above aspects, the potential is a varying potential and the signal is detected as an intercalation potential.

In any or all of the above aspects, the potential is a fixed potential and the signal is detected as a change in current.

In any or all of the above aspects, a detected concentration of the one or more anions in the sample ranges from 1 nanomolar to 1 molar.

In any or all of the above aspects, the one or more anions comprise a first anion species and a second ion species, and wherein the first anion species is different from the second anion species.

In any or all of the above aspects, the one or more anions further comprise a third anion species, and wherein the third anion species is different from the first anion species and the second anion species.

In any or all of the above aspects, the method further comprises further comprising applying a negative voltage to de-intercalate the one or more anions from pores of the MOF nanoparticles.

Also disclosed herein is an electrochemical analyte sensor comprising a working electrode functionalized with a plurality of crystalline metal-organic framework (MOF) nanoparticles having a pore size ranging from greater than 4.5 Å to less than 10 Å; a counter electrode; and a reference electrode.

In some aspects of the present disclosure, the electrochemical analyte sensor further comprises a control unit comprising (i) a power component for applying an electrical potential to the working electrode; and/or (ii) a measuring component for measuring a voltage and/or a current.

In any or all of the above aspects, the electrochemical analyte sensor further comprises an electrolyte-containing solution comprising one or more cations, wherein the electrolyte-containing solution is an organic solution or an aqueous solution.

In any or all of the above aspects, (i) the power component is selected from a power supply, a voltage supply, a potentiostat, or any combination thereof; and wherein (ii) the measuring component is selected from a voltmeter, a potentiometer, an ammeter, a resistometer, or any combination thereof.

Also disclosed herein is a method of using the electrochemical analyte sensor, comprising exposing the electrochemical analyte sensor to a liquid sample; and applying a varying potential between the working electrode and the counter electrode.

In some aspects of the present disclosure, the method further comprises further measuring an intercalation potential associated with intercalation of one or more anions with the Cr(1,2,3-triazolate)₂ MOF nanoparticles, wherein the one or more anions are selected from F⁻, I⁻, Cl⁻, or B⁻, BF₄_{^{−}}, ClO₄_{^{−}}, PF₆_{^{−}}, OTf⁻, C₂N₃_{^{−}}, CF₃SO₂NH⁻, or any combination thereof.

### VII. Examples

Materials: All commercial chemicals were used as received and handled under inert conditions unless stated otherwise. Solvents were collected from a solvent purification system and stored over 4-Å molecular sieves, and all liquid reagents were freeze-pump-thawed in four cycles prior to use. N,N-dimethylformamide (DMF, ACS grade, Fisher Scientific), acetonitrile (MeCN, HPLC grade, Fisher Scientific), iron(II) chloride (98%, anhydrous, Strem), 1-methylimidazole (99%, Sigma-Aldrich), 1,2,3-triazole (≥98%, TCI), tetrabutylammonium hexafluorophosphate (98%, TCI, recrystallized once from ethanol), tetrabutylammonium tetrafluoroborate (98%, ACROS, recrystallized once from ethanol), tetrabutylammonium perchlorate (99+%, Fisher Scientific), tetrabutylammonium triflate ((>98.0%, TCI Chemicals), potassium chloride (99.0-100.5%, ACS, Thermo Scientific), potassium bromide (ACS, 99%, Alfa Aesar), potassium iodide (ACS grade, Fisher Scientific), potassium sulfate (ACS reagent, >99%, Sigma-Aldrich), potassium perchlorate (ACS reagent, ≥99% Sigma-Aldrich), potassium triflate (>98.0%, TCI Chemicals).

Synthesis of Fe(TA)₂ and Cr(TA)₂ Nanoparticles: The MOF nanoparticles were synthesized using 1-methylimidazole (1-mlm) as a modulator. Specifically, a solution of anhydrous iron(II) chloride in DMF (0.805 mmol, 0.0575 M, 14 mL) was first prepared, followed by the addition of 45.5 uL (0.709 equiv) of 1-mlm for the synthesis of 17-nm nanoparticles. Equivalents are with respect to iron(II) chloride. The vials were further heated under 120° C. for 1.5 hours and then immediately centrifuged and washed twice with DMF. For the Cr(TA)₂ nanocrystal synthesis, 1,2,3-triazole (7.5 mmol, 0.26 mL, 3 eq) and 1-mlm (0.25 mmol, 20 μL, 0.1 eq) were added to a solution of chromium triflate (Cr(CF₃SO₃)₂) in DMF (2.5 mmol, 0.25 M, 10 mL). Vials were further heated under 120° C. for 48 hours and then immediately centrifuged and washed twice with DMF. The precursor, chromium triflate (Cr(CF₃SO₃)₂) was made by pipetting triflic acid (10 g) into a flask of water (10 mL) under nitrogen. The flask was sparged for 7 min, and a reflux condenser was added immediately after the addition of chromium (2.1 g). The flask was placed on a hot plate, preheated to 85° C. for 5 hours. The solution was poured into a new flask over a liquid funnel with a cotton plug. The flask was evacuated on a Schlenk line at 170° C. for several hours, and a pale teal powder was yielded. The product was stored in an N₂ glovebox. FIG. 2B is a graph showing the PXRD patterns and the Rietveld refinement fittings for the MOF nanocrystal comprising Cr(TA)₂ and FIG. 2C is the SEM image showing 25 nm-nanocrystals MOF comprising Cr(TA)₂. FIG. 2D is a graph showing the PXRD patterns and the Rietveld refinement fittings for Fe(TA)₂ and FIG. 2E is an SEM image of the 17-nm MOF nanocrystals comprising Fe(TA)₂.

XRD Measurements and Analysis: Powder XRD (PXRD) data were collected in the air using Bragg-Brentano geometry with a step size of 0.02° in the range of 3.5-35° 2θ with a Bruker D2 Phaser. A variable detector opening was used to reduce air scattering at low angles. Patterns were matched to the low-spin Fe(TA)₂ cif file. The film was studied by grazing incidence XRD on a Rigaku SmartLab diffractometer with Cu Ka radiation and parallel-beam/parallel slit analyzer optics over a 2θ range of 5-35°.

SEM Imaging for Size Analysis: Imaging was performed using a Thermo Fisher Apreo 2 SEM instrument with 10.00 kV energy and 0.8 nA current. SEM samples were prepared by spin-coating the dispersion of Fe(TA)₂ nanoparticles in DMF onto silicon substrates. Particle sizing was performed in ImageJ.

Numerical Simulations: Calculations were performed using spin-polarized density functional theory (DFT) as implemented in the Vienna ab initio simulation package (VASP, version 5.4.4). Structures were equilibrated using the unrestricted GGA-PBEsol exchange correlation functional with the projected augmented-wave (PAW) method. Ionic relaxation was achieved when all forces were smaller than 0.01 eV/Å. The plane-wave cutoff was set at 500 eV, and the SCF convergence criterion was 1×10⁻⁰⁵ eV. Because of the large unit cells, the structures were optimized with a Γ-only k-grid using non-spin-polarized calculations. The transition state energy barrier was calculated using the climbing image nudged elastic band (CI-NEB) method.

X-Ray Photoelectron Spectroscopy: XPS measurements were performed on an ESCALAB 250 (ThermoScientific) using Al Kα monochromated (20 eV pass energy, 500 μm spot size). The samples were charge-neutralized via an in-lens electron source. Spectra were analyzed with ThermoScientific Avantage 5.99 software. The binding energies were calibrated to the C 1s signal at 284.8 eV.

In Situ Electrochemical Raman Measurements: In situ electrochemical Raman studies were conducted using a home-made electrochemical Raman cell, where a silver wire, a Pt wire electrode, and 0.1-M TBABF₄ in acetonitrile were employed as the reference, counter electrode, and electrolyte solution respectively. A MOF nanoparticle film on a Pt/Ti/Si substrate prepared by e-beam deposition was used as the working electrode. All electrochemical data were collected using a Biologic SP200. After applying potentials for 5 minutes, Raman spectra were taken using a 633-nm laser (Iₒ=0.9 mW/cm²) and a 20× objective lens (N.A. 0.4). To protect the lens from the solution, it was covered with a 13 μm-thick Teflon sheet (American Durafilm, Inc.). The spectra were obtained after series mode with 16 scans and a 10 s integration time for each scan.

Electrochemical Studies of Metal Triazolate MOF Nanoparticle Film: All electrochemical data were collected using a Biologic SP200. For electrochemical quartz crystal microbalance (EQCM) experiments, the Pt/Ti-coated 5 MHz AT-cut QCM working electrodes were cleaned using acidic piranha solution, then rinsed copiously with 18.2 MΩ nanopure water, followed by isopropyl alcohol, and lastly dried under positive N₂ pressure. 3-4 μg of Cr(TA)₂ and Fe(TA)₂ nanoparticle suspensions in DMF were spin-coated onto EQCM electrodes in a N₂ glovebox. The EQCM electrodes with Cr(TA)₂ and Fe(TA)₂ films were further dried in the vacuum for 3 hours. A standard three-electrode electrochemical cell was set up with 0.1-M electrolytes (i.e., TBABF₄, TBAPF₆, TBAClO₄, and TBAOTf) in acetonitrile (80 mL), the EQCM as the working electrode, a platinum wire as the counter electrode, and a bare silver wire as a pseudo-reference electrode. Frequency data were collected simultaneously with CV scans using a SRS QCM200 apparatus. The frequency was converted to mass using Equation 2 below, where Δf is the experimental change in frequency, Cf is the sensitivity factor (56.6 Hz cm² μg⁻¹ for 5 MHz AT-cut crystals), and Δm is the change in mass.

$$Δ f = - Cf ( Δ m ) \qquad Equation 2$$

Cyclic voltammogram (CV) traces of Cr(TA)₂ and Fe(TA)₂ films were collected under N₂ conditions at a scan rate of 10 mV/s. For scan-rate-dependent measurements, CV measurements were conducted in 0.1-M TBABF₄ at scan rates of 10, 40, 100, 300, and 500 mV/s, respectively. The double-layer capacitance currents are subtracted from the total current density to exclude interference when identifying the relationship between the scan rate and the current density of redox features from Cr(TA)₂ MOFs.

The electrochemical studies into titration and sensing of anions were conducted using a glassy carbon (GC) as the working electrode. To prepare the working GC electrode, Cr(TA)₂ nanoparticles were suspended in DMF at a concentration of 1 mg/mL and then drop-casted (15 μL) onto the polished GC surface. The electrode was further dried in a vacuum for 3 hours before electrochemical studies. For electrochemical anion sensing in organic solutions, a standard three-electrode electrochemical cell was set up with 0.1-M TBA⁺-based electrolytes in acetonitrile (16 mL), the GC as the working electrode, a platinum wire as the counter electrode, and a bare silver wire as a pseudo-reference electrode. For electrochemical anion sensing in aqueous solutions, a standard three-electrode electrochemical cell was set up with 0.1-M K⁺-based electrolytes in water (45 mL), the GC as the working electrode, a platinum wire as the counter electrode, and an Ag/AgCl reference electrode. To prevent the leakage of trace amounts of Cl⁻ from reference electrode during sensing experiments, double-junction Ag/AgCl reference (Pine Research, RREF0024) was used, where the inner solution comprised 4-M KCl and the outer solution comprised 0.1-M KOTf. The CV measurements were conducted at the scan rate of 10 mV/s under N₂ conditions. All the CV results shown in the manuscript have been electrochemically conditioned.

### Example 1

In this example, anion intercalation (positive potential) and de-intercalation (negative potential) processes inside the Cr(TA)₂ pores of an electrochemical sensor comprising Cr(TA)₂ nanoparticles were investigated. More specifically, distinct intercalation barriers of different anions involving different energy inputs (e.g., applied voltage) to drive ion transportation into the pores of the Cr(TA)₂ nanoparticle was investigated.

FIG. 2A is a cyclic voltammogram of anion-intercalation-induced redox chemistry of the Cr(TA)₂ pores demonstrating a sharp and reversible “butterfly” signature originating from anion-intercalation-induced Cr redox chemistry inside Cr(TA)₂ pores. Moreover, the E_{1/2} of intercalation redox feature shifted to the more positive potentials when using larger anions (e.g., BF₄_{^{−}}<ClO₄_{^{−}}<PF₆_{^{−}}<OTf⁻) as electrolytes, demonstrating that larger anions involve a higher electrochemical potential across the electrode/electrolyte interface to drive the intercalation of anions into the nanoconfined Cr(TA)₂ pores.

Accordingly, cyclic voltammogram studies that are dependent on anions demonstrate that the intercalation redox chemistry of Cr(TA)₂ can be employed to detect the anions present in a solution by measuring the E_{1/2} value.

### Example 2

In this example, the electrochemical sensor comprising Cr(TA)₂ nanoparticles was used to detect trace amounts ClO₄_{^{−}} anions; the presence of ClO₄_{^{−}} and BF₄_{^{−}} anions; and the presence of trace amounts of Cl⁻ anions.

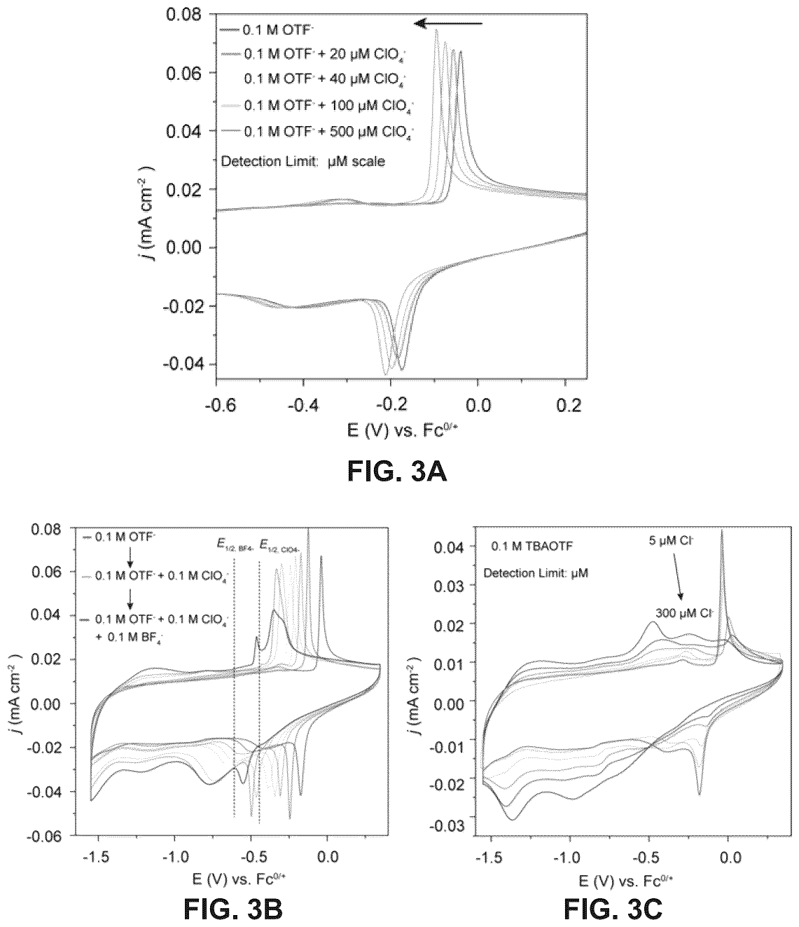

FIG. 3A is the CV of Cr(TA)₂ in the presence of trace amounts of ClO₄_{^{−}} anions and demonstrating the detection of the ClO₄_{^{−}} anions by the shift in E_{1/2} position of the intercalation redox feature from its original value of E_{1/2, OTF-} toward E_{1/2, ClO4-} (see example 1; FIG. 2A). FIG. 3B is the is the CV of Cr(TA)₂ in the presence of ClO₄_{^{−}} and BF₄_{^{−}} anions exhibiting a CV redox signature that is in proximity to E_{1/2, BF4-} was observed after the titration of secondary BF₄_{^{−}} anions into ClO₄_{^{−}}/OTf⁻ solution.

In addition to ClO₄_{^{−}} anions, FIG. 3C shows that the intercalation redox feature of Cr(TA)₂ exhibits a response in the presence of trace amount of halide anions, such as Cl⁻ anions. Distinct from the ClO₄_{^{−}}-induced E_{1/2} shift, it was found that Cl⁻ anions reduce the current density of intercalation redox feature from Cr(TA)₂ nanocrystals. Without being bound by a theory of operation, the decreased current densities observed with Cl⁻ likely may arise from its tendency to strongly bind to interior Cr active sites, in a similar manner to the “poisoning effect” of carbon monoxide molecules adsorbing on the platinum surface.

Accordingly, these anion-dependent investigations demonstrate that the use of Cr(TA)₂ nanocrystals in voltammogram measurements allows for the simultaneous sensing of multiple anions in an analyte.

### Example 3

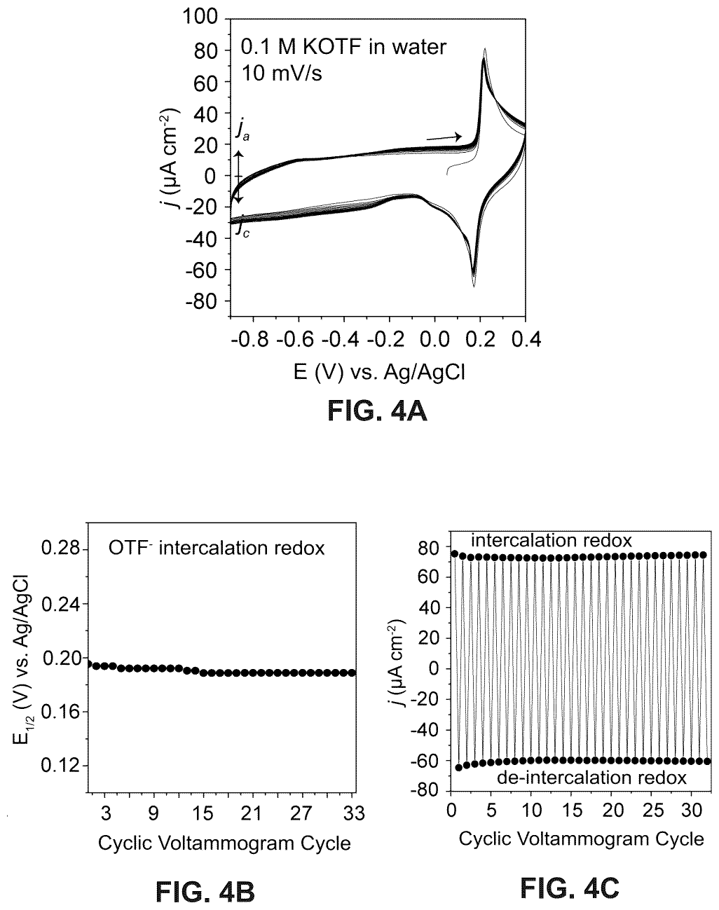

In this example, a stability test of anion-intercalation redox inside the Cr(TA)₂ pores of electrochemical analyte sensor in aqueous media was conducted. FIG. 4A shows the cyclic voltammetry of Cr(TA)₂ in 0.1 M KOTf water electrolyte. FIG. 4B shows the E_{1/2} of intercalation redox feature in multiple CV scans. FIG. 4C shows the current density of the intercalation redox feature in multiple CV scans. FIG. 5A is the cyclic voltammogram of Cr(TA)₂ in a 0.1 M TBAOTf/water electrolyte. FIG. 5B shows the current density of intercalation redox feature in multiple CV scans.

FIG. 4A demonstrates Cr(TA)₂ stability in cyclic voltammetry in aqueous media. The OTf⁻ intercalation-induced redox feature in Cr(TA)₂ remains observable at approximately 0.2 vs. Ag/AgCl in water. FIGS. 4B-4C demonstrate that E_{1/2, OTf-} and the corresponding current density of this intercalation feature barely change during the long-term CV stability test (approximately 30 CV cycles over 3-4 hours). FIGS. 5A-5B demonstrates Cr(TA)₂ stability in cyclic voltammetry in H₂O/MeCN (8:1) and that E_{1/2, OTf-} and the corresponding current density of this intercalation feature barely change during the long-term CV stability test (approximately 28 CV cycles).

Therefore, this example demonstrates that Cr(TA)₂ nanocrystals are capable of selectively sensing anions in aqueous analytes.

### Example 4

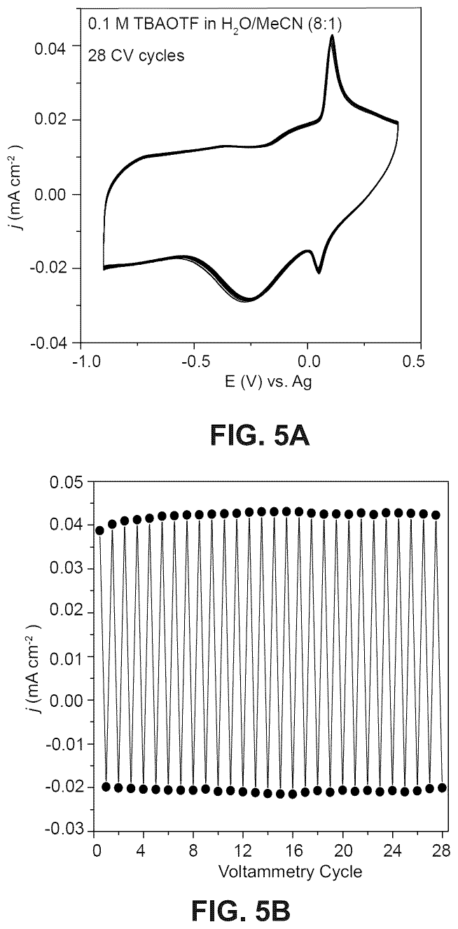

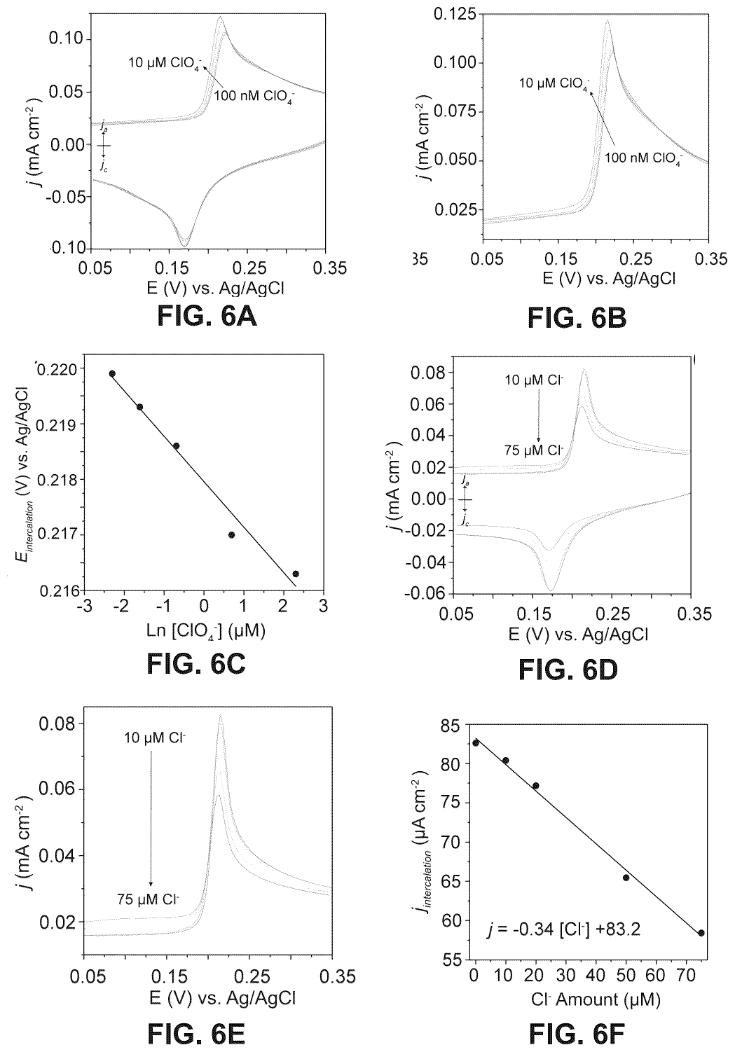

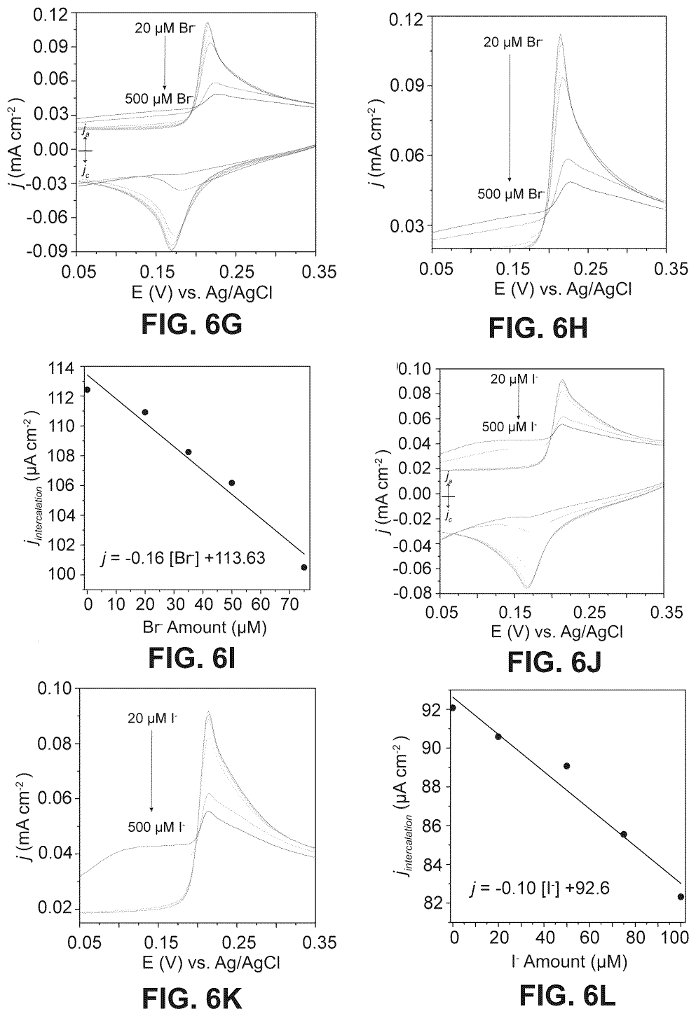

In this example, the Cr(TA)₂ nanoparticles of the electrochemical analyte sensor were investigated for detecting anions in aqueous media at low concentrations (e.g., 100 nanomolar). FIGS. 6A-6B depict CV of Cr(TA)₂ in the presence of trace amounts of ClO₄_{^{−}} anions. FIGS. 6A-6B demonstrate that Cr(TA)₂ can detect ClO₄_{^{−}} anions in aqueous media at concentrations as low as approximately 100 nanomolar, as evidenced by the shift in E_{1/20}f the intercalation redox feature towards a smaller value. This E_{1/2} shift is found to be proportional to the Ln[ClO₄_{^{−}}], as shown in FIG. 6C, following the Nernst equation.

Unlike ClO₄_{^{−}}, halide anions cause a decrease in the current density of the Cr(TA)₂ intercalation feature at micromolar scales, as illustrated in FIGS. 6D-6E, 6G-6H, 6J-6K instead of a shift in E_{1/2}, OTf⁻. Consistent with the electrochemical measurements in organic solvents, this decrease in current density is attributed to the tendency of halide anions to strongly bind to interior Cr active sites, thus obstructing the OTf-induced interior Cr^{2+/3+} redox chemistry. FIG. 6F, FIG. 6I, and FIG. 6L show the sensitivity, which is defined as the slope in the plot of current density vs. [halide anions], decreases continuously as the anion size increases from Cl⁻ to I⁻. Thus, this example demonstrates that Cl⁻ anions are easier to intercalate into the Cr(TA)₂ pores and block the interior redox active Cr centers than larger Br⁻ and I⁻ anions.

### Example 5

In this example, the impact of pore size on redox intercalation energetics of an electrochemical analyte sensor comprising Fe(TA)₂ nanoparticles (spin-coating amount of 17-nm Fe(TA)₂ nanoparticles onto EQCM crystal was ca. 4.0 μg) was comparted to an electrochemical analyte sensor comprising Cr(TA)₂ nanoparticles (the spin-coating amount of 25-nm Cr(TA)₂ nanoparticles onto EQCM crystal is ca. 3.4 μg). CV traces and the mass-to-charge ratio were collected using EQCM electrodes and 0.1-M tetrabutylammonium tetrafluoroborate (TBABF₄) was used as electrolyte in acetonitrile and the CV was collected at a 10 mV/s scan rate.

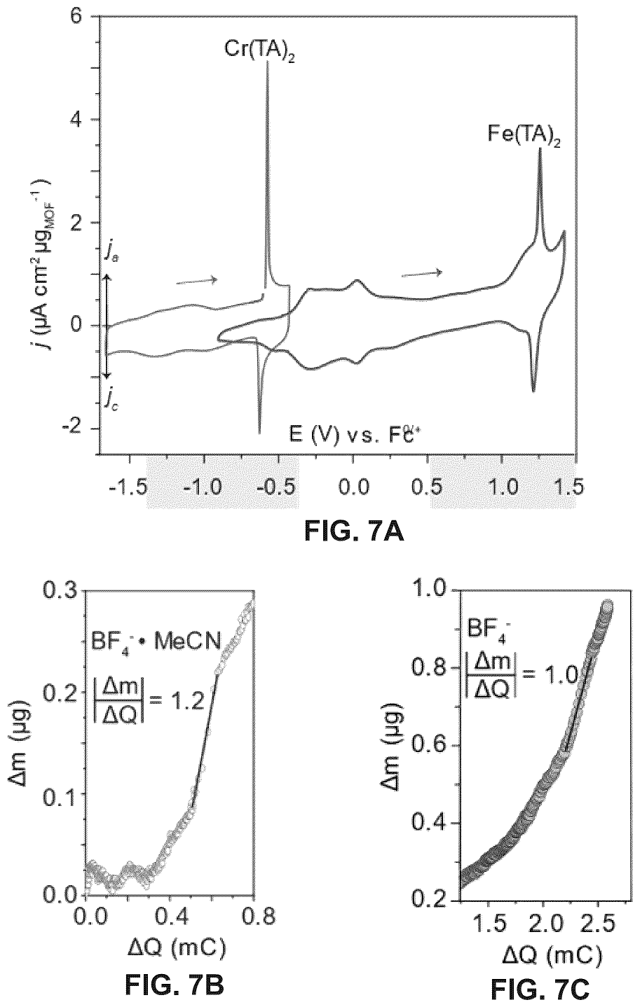

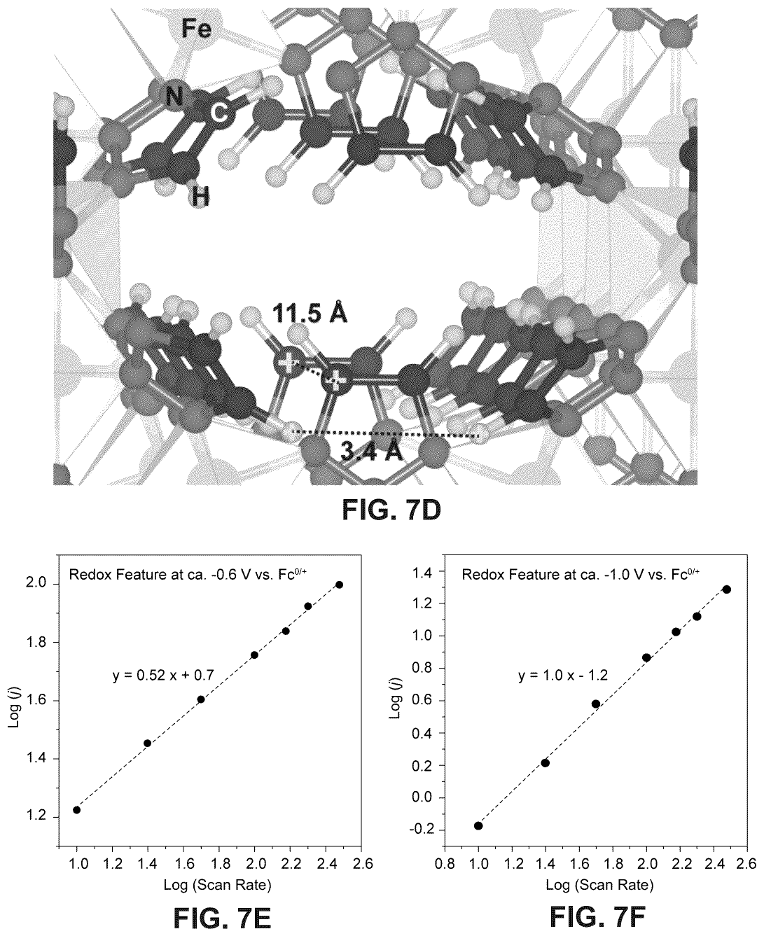

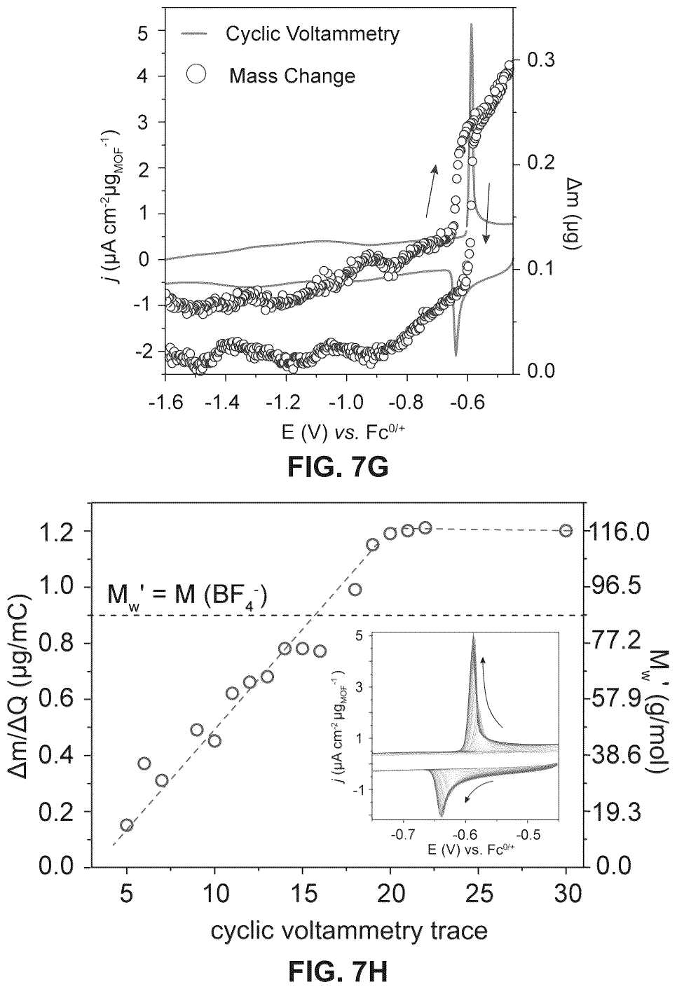

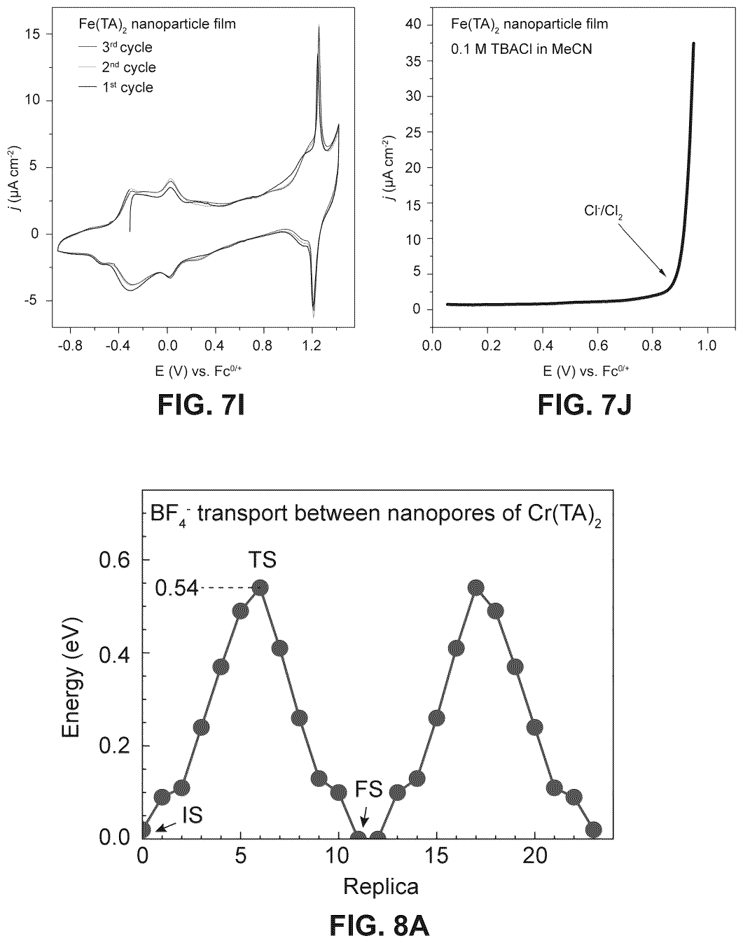

FIGS. 7A-7C show the results for the electrochemical quartz microbalance electrodes comprising Cr(TA)₂ and Fe(TA)₂. FIG. 7D is a schematic showing the pore structures inside of Fe(TA)₂, demonstrating a distance of 11.5 Å between the C-C (black dots) and a distance of 3.4 Å between the H-H (gray dots). FIGS. 7E-7F are graphs showing plots of log(j) vs log(scan rate) for −0.6 and −1.0 V redox feature, respectively, of Cr(TA)₂ nanoparticle film at varying scan rates.

With reference to FIG. 7A, the BF₄_{^{−}}-intercalation-induced Fe^{2+/3+} chemistry of Fe(TA)₂ nanoparticle films exhibited a sharp and reversible redox feature at ca. 1.2 V vs Fc^{0/+}, the solvated BF₄_{^{−}} anions (diameter of ca. 10 Å) exceed the ca. 3.4 Å pore diameter of Fe(TA)₂ nanopore as indicated by the H-H distance shown in FIG. 7D. Accordingly, without being bound by a theory of operation, the potential of 1.2 V vs Fc^{0/+} was generated from the additional driving force for complete de-solvation and intercalation of bare BF₄_{^{−}} anions (diameter of ca. 3 Å).

In view of FIG. 7E, the scan-rate-dependent CV studies indicated that the current density of this −0.6 V voltametric feature relates to the squared root of scan rate, identifying the origin of this redox feature as a diffusion-controlled process. In contrast with the scan-rate-dependent behavior of −0.6 V redox peak of FIG. 7E, FIG. 7F shows that the current density (j) of the redox feature at ca. −1.0 V vs. Fc^{0/+} is proportional to the scan rate. Without being bound by a theory of operation, this result indicates that the −1.0 V redox signature is a surface-adsorption-controlled process and therefore originates from BF₄_{^{−}}-adsorption-induced Cr redox chemistry on the Cr(TA)₂ surface. Moreover, the surface redox feature also cathodically shifts from ca. 0 V vs. Fc^{0/+} on Fe(TA)₂ to ca. −1.0 V vs. Fc^{0/+} on Cr(TA)₂ nanoparticles. Thus, the distinct surface structures between Fe(TA)₂ and Cr(TA)₂ nanoparticles result in different energies for partial desolvation of BF₄_{^{−}} and can impact the subsequent adsorption of BF₄_{^{−}} on the surface active centers, leading to the metal-center-dependent E_{1/2} position of the surface redox feature.

In addition to the shift in intercalation redox feature between Cr(TA)₂ and Fe(TA)₂ nanocrystal films, the E_{1/2} difference between surface redox and intercalation redox also decreases from 1.2 V in Fe(TA)₂ to 0.4 V in Cr(TA)₂ nanoparticle film (see FIG. 7A). The E_{1/2} difference demonstrates the attenuation of the gating effect and the lower energy input involved in triggering the BF₄_{^{−}} intercalation redox chemistry inside Cr(TA)₂ nanopores as compared to Fe(TA)₂. FIG. 7G shows the EQCM measurements of the Cr(TA)₂ nanoparticle film (CV (solid green line) and mass change (blue dotted line)) were collected in the TBABF₄ acetonitrile solution at a 10-mV/s scan rate. In view of FIG. 7G, the in situ electrochemical quartz crystal microbalance (EQCM) electrodes also detected a significant mass increase at the −0.6 V redox peak, further relating this redox feature with the mass transport of BF₄_{^{−}} anions into the Cr(TA)₂ nanocrystal pores.

To create an empty nanopore environment, native OTf-anions originating from synthesis are removed. FIG. 7H is a graph showing the CV-trace-dependent mass-to-charge ratio and the corresponding apparent molecular mass during the conditioning period of Cr(TA)₂ film. The insert shown in FIG. 7H is a graph showing the conditioning CV traces of Cr(TA)₂ nanoparticle films in the potential region of BF₄_{^{−}}-intercalation-induced redox feature. The CV traces and mass-to-charge ratio were collected using EQCM electrodes and 0.1-M tetrabutylammonium tetrafluoroborate (TBABF₄) as electrolyte in acetonitrile. The spin-coating amount of 25-nm Cr(TA)₂ nanoparticles onto EQCM crystal is ca. 3.4 μg. CV is collected at a 10 mV/s scan rate. This multi-anion transport process results in a prolonged conditioning period for the Cr(TA)₂ nanocrystal film, where the BF₄_{^{−}} intercalation redox feature appears after 5 CV traces, with current densities increasing until reaching equilibrium after approximately 40 traces as shown in FIG. 7H.

Accordingly, the apparent molecular mass (M′_{w}) reflects the net effect of de-intercalation of OTf⁻ anions (mass decrease) and the intercalation of BF₄_{^{−}} anions (mass increase) within the confined pores of Cr(TA)₂ nanoparticles. As shown in FIG. 7H, M′_{w} remains below the expected molecular weight of BF₄_{^{−}} anions (denoted as the dashed line in FIG. 7H) for the first 15 CV traces, which indicates that the de-intercalation of OTf⁻ anions from the pores of Cr(TA)₂ directed these initial scans. Cycling the scans causes both current and mass-to-charge ratio changes to increase progressively until ca. 20 scans (see FIG. 7H). During this cycling, the redox peak cathodically shifts ca. 50 mV, demonstrating that redox intercalation becomes more desirable. Cr(TA)₂ films can be subjected to a conditioning period to remove native OTf⁻ and increase BF₄_{^{−}} intercalation. Accordingly, the cathodic shift of the BF₄_{^{−}} intercalation redox feature from ca. 1.2 V vs Fc^{0/+} in Fe(TA)₂ to ca. −0.6 V vs Fc^{0/+} in Cr(TA)₂ nanoparticle film demonstrates the desirable transport of BF₄_{^{−}} anions into the pores of Cr(TA)₂ nanocrystals.

After the conditioning period, M′_{w} equilibrates at ca. 116.0 g/mol larger than the molecular weight of BF₄_{^{−}} anions, indicating that the BF₄_{^{−}} anions intercalate with an acetonitrile solvation shell. Further, the XPS demonstrates that approximately 50% of the native OTf⁻ anions were removed from the pores of Cr(TA)₂ after the conditioning period. FIG. 7I is a line graph showing the trace-dependent CV of Fe(TA)₂ nanoparticle film in 0.1-M TBABF₄ acetonitrile solution, wherein the CV traces were collected at a 10-mV/s scan rate. FIG. 7J is a line graph showing the j-V measurement of Fe(TA)₂ nanoparticle film in 0.1-M TBACl acetonitrile solution. With reference to FIG. 7I, Fe(TA)₂ nanoparticle films exhibited a lower conditioning period, as evidenced by an equilibrium after 3 CV cycles. While Fe(TA)₂ possesses native Cl⁻ anions upon isolation from synthesis, the oxidation of Cl⁻ anions to Cl₂ occurs before the BF₄_{^{−}}-induced intercalation redox at ca. 1.2 V vs Fc^{0/+} as shown in FIG. 7J, demonstrating that nanopores undergo a self-cleaning step.

Analysis of the differing CV peak shapes for the Fe and Cr materials provides insight into mechanistic differences between the two intercalation processes. Specifically, whereas the feature at ca. 1.2 V vs Fc^{0/+} in Fe(TA)₂ include a pre-wave (i.e., in the potential range of ca. 1.0 V-1.2 V vs Fc^{0/+}) and a sharp peak, but only a sharp feature exists for Cr(TA)₂ at ca. −0.6 V vs Fc^{0/+} (see FIG. 7A). The pre-wave observed with Fe(TA)₂ was assigned previously to adsorption and desolvation of BF₄_{^{−}} anions prior to intercalation into the nanoconfined pores. Accordingly, the absence of a pre-wave for the Cr(TA)₂ nanoparticle film indicates that BF₄_{^{−}} anions intercalate without complete desolvation.

### Example 6

To further investigate interfacial BF₄_{^{−}} transfer, the mass and charge changes were monitored at the intercalation redox events for both Cr(TA)₂ and Fe(TA)₂ nanoparticle films using in situ EQCM. The apparent molecular mass (M′_{w}) of a species was measured using Equation 3 below.

$${M}_{w}^{′} = zF ( \frac{Δ m}{Δ Q} ) \qquad Equation 3$$

With reference to Equation 3, z represents the number of electrons and F is Faraday's constant. From M′_{w}, the solvation number (n) of BF₄_{^{−}} anions involved during the intercalation/de-intercalation process were determined using Equation 4 below.

$$n = \frac{{M}_{w}^{′} - {M}_{w} ( B {F}_{4}^{-} )}{{M}_{w} ( solvent )} \qquad Equation 4$$

With reference to Equation 4, M_{w}(BF₄_{^{−}}) denotes the molecular weight of BF₄_{^{−}} anions and M_{w}(solvent) is the molecular weight of solvent (e.g., acetonitrile). Without being bound by a theory of operation, the theoretical slope of Δm/ΔQ is ca. 0.9 (at n=0 and M′_{w}=M_{w}(BF₄_{^{−}})) if the BF₄_{^{−}} anions intercalate into either Cr(TA)₂ or Fe(TA)₂ nanopores without a solvation shell. As shown in FIGS. 7B-7C, the slope of Δm/ΔQ (ca. 1.0) at the intercalation feature of Fe(TA)₂ nanocrystals approaches the theoretical value expected for the complete desolvation process. By contrast, for Cr(TA)₂, a Δm/ΔQ slope of ca. 1.2 was observed (see FIG. 7G), which exceeds the theoretical value of complete desolvation (ca. 0.9), indicating that BF₄_{^{−}} anions transfer into nanopores with acetonitrile molecules (i.e., a partial desolvation interfacial transfer mechanism).

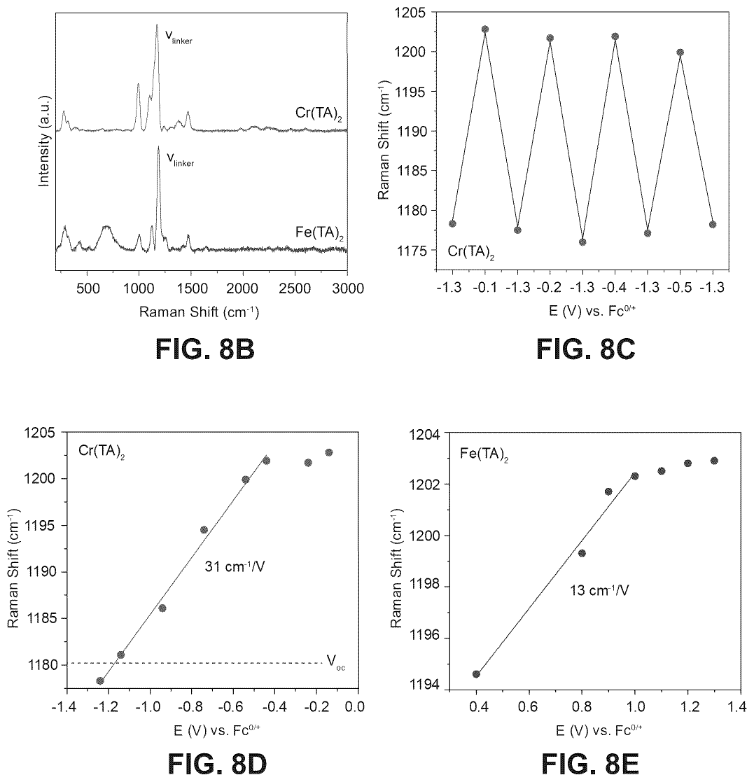

Furthermore, FIG. 8A is a line graph showing the DFT calculations using the climbing image nudged elastic band (CI-NEB) method used to determine the activation barrier of BF₄_{^{−}} intercalation in Cr(TA₂ nanoconfined pores. In view of FIG. 8A, the DFT calculations demonstrated an energetic barrier of 0.54 eV for BF₄_{^{−}} anions transporting between the nanopores of Cr(TA)₂, which are lower than the larger barrier of ca. 0.84 eV for Fe(TA)₂.

Changes to metal-linker bonding during intercalation and de-intercalation were investigated by performing in situ electrochemical Raman spectroscopy on the first film comprising Cr(TA)₂ nanoparticles and the second film comprising Fe(TA)₂ nanoparticles. FIGS. 8B-8D show the results from the Cr(TA)₂ and Fe(TA)₂ nanoparticle films monitored during operando Raman spectroscopy under the relevant electrochemical conditions shown. The far greater redshift slope of the Cr(TA)₂ triazolate vibrational modes compared to Fe(TA)₂ (31 cm⁻¹/K vs 13 cm⁻¹/K), demonstrates greater bond flexibility in the Cr system, which may facilitate the intercalation process.

Raman signatures of the triazolate vibrational signature at ca. 1180 cm⁻¹ (denoted as vₗᵢₙₖₑᵣ in FIG. 8B) reported changes to metal-linker bonding during intercalation/de-intercalation processes. FIG. 8C shows that vlinker blue-shifts under the potentials that enable the BF₄_{^{−}}-intercalation-induced Cr^{2+/3+} oxidation, which then red-shifts with an applied voltage of −1.3 V vs Fc^{0/+} to trigger BF₄_{^{−}} de-intercalation and Cr³⁺ reduction. These results demonstrate the reversibility of the metal-linker dynamic bonding and exclude the indication of permanent structural transformation within Cr(TA)₂ nanoparticles during the interfacial ionic redox chemistry. In view of FIG. 8D, the vlinker first exhibits a blue-shift slope of ca. 31 cm⁻¹/V between ca. −1.3 V to ca. −0.4 V vs Fc^{0/+}, which decreases at more positive potentials. The change in the blue shift slope can be attributed to the different abilities of mix-valent Cr²⁺/Cr³⁺ versus Cr³⁺ centers to back-bond. By contrast, as can be seen in FIG. 8E, the blue-shift slope of vₗᵢₙₖₑᵣ in Fe(TA)₂ nanocrystals is only ca. 13 cm⁻¹/V before becoming less dependent on the applied potential. This comparison indicates a greater change to the bonding and overall structural environments of Cr(TA)₂ as compared to Fe(TA)₂.

The EQCM, theoretical, and spectroscopic results disclosed in this example demonstrate that the pore enlargement further reduces the gating effect on the entry of BF₄_{^{−}} anions, resulting in a massive potential shift in the intercalation redox feature from ca. 1.2 V vs Fc^{0/+} in Fe(TA)₂ to ca. −0.6 V vs Fc^{0/+} in Cr(TA)₂ nanocrystal film.

### Example 7

In this example, the impact of the electrolyte identity and the intercalation redox chemistry within the pores of Cr(TA)₂ of the electrochemical sensor were investigated by substituting BF₄_{^{−}} anions for larger anions ClO₄_{^{−}}, PF₆_{^{−}}, and OTf⁻, while keeping bulky tetrabutylammonium (TBA⁺) as the counter cation.

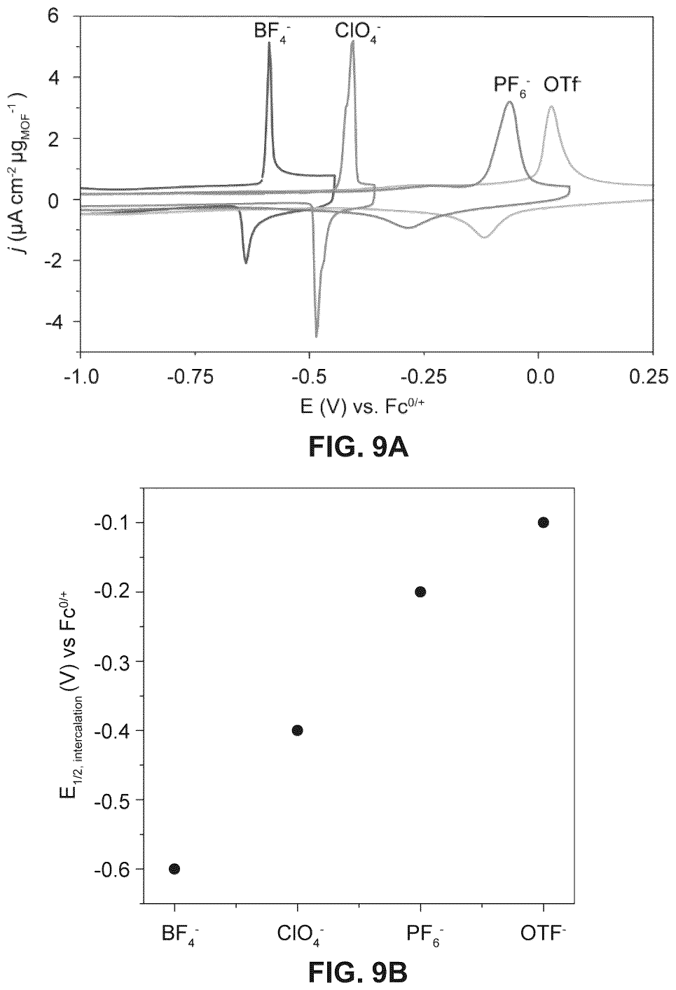

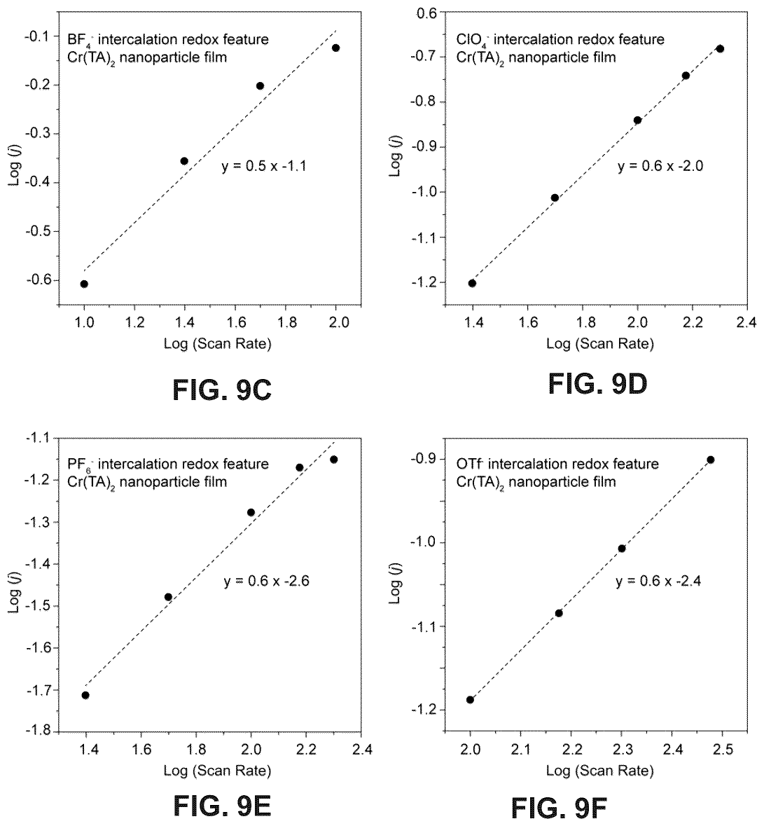

FIG. 9A is a graph showing the anion-dependent CV measurements of Cr(TA)₂ nanoparticle films. FIG. 9B is a graph showing the anion-dependent CV trace collected using EQCM electrodes in a 0.1-M electrolyte acetonitrile solution, wherein the counter cation in the electrolyte was TBA⁺ and the spin-coating amount of 25-nm Cr(TA)₂ nanoparticles on EQCM is ca. 3-4 μg. FIG. 9C is a graph showing the plot of anion-dependent log(j) vs log(scan rate) for the −0.6 V redox feature of Cr(TA)₂ film in TBABF₄. FIG. 9D is a graph showing the plot of anion-dependent log(j) vs log(scan rate) for the −0.4 V redox feature of Cr(TA)₂ film in TBAClO₄. FIG. 9E is a graph showing the plot of anion-dependent log(j) vs log(scan rate) for the −0.2 V redox feature of Cr(TA)₂ film in TBAPF₆. FIG. 9F is a graph showing the plot of anion-dependent log(j) vs log(scan rate) for the −0.1 V redox feature of Cr(TA)₂ film in TBAOTf.

FIGS. 9A-9B exhibit a large anodic shift to the E_{1/2} of the intercalation redox feature from ca. −0.6 V vs Fc^{0/+} to ca. −0.1 V vs Fc^{0/+} upon switching the anion identity from the smallest anion BF₄_{^{−}} to increasingly larger ClO₄_{^{−}}, PF₆_{^{−}}, and OTf⁻. Scan-rate-dependent CV results shown in FIGS. 9C-9F indicate that the current density of these anion-dependent sharp voltametric features relate to the squared root of scan rate, identifying the origin of ClO₄_{^{−}}, PF₆_{^{−}}, and OTf⁻-induced redox features as a diffusion-controlled process.

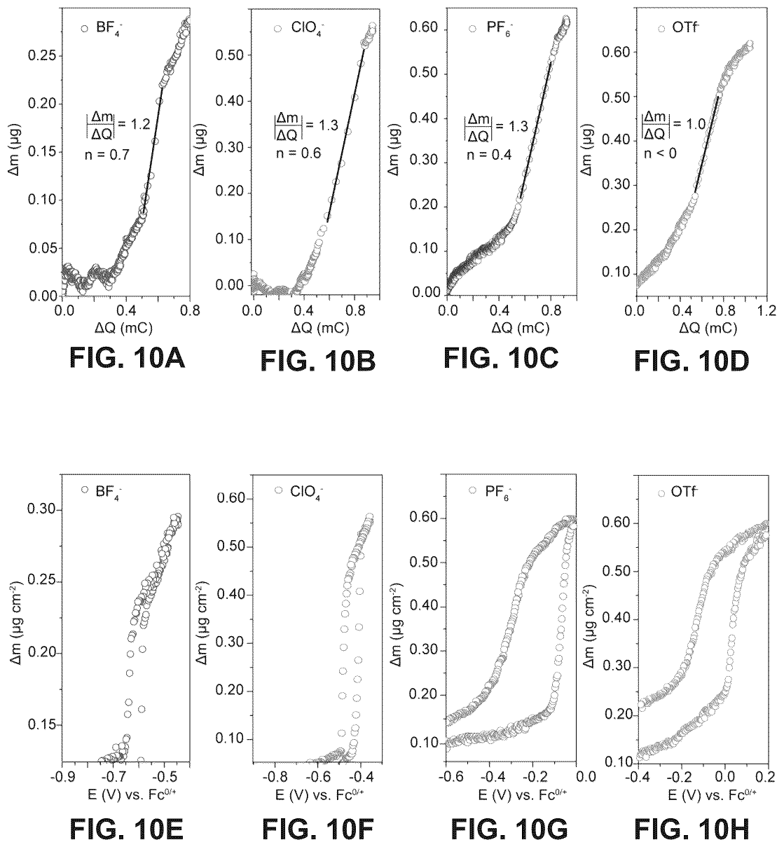

To further identify the origin of this anion-dependent intercalation redox behavior, Δm/ΔQ and the corresponding solvation number (n) when using each anion were recorded. FIG. 10A is a graph showing the mass-to-charge ratio at the intercalation redox event with BF₄_{^{−}} into a Cr(TA)₂ film. FIG. 10B is a graph showing the mass-to-charge ratio at the intercalation redox event with ClO₄_{^{−}} into a Cr(TA)₂ film. FIG. 10C is a graph showing the mass-to-charge ratio at the intercalation redox event with PF₆_{^{−}} into the Cr(TA)₂ nanoparticles. FIG. 10D is a graph showing the mass-to-charge ratio at the intercalation redox event with OTf⁻ into a Cr(TA)₂ film. FIGS. 10A-10D demonstrate a continuous decrease in the n value for larger-size anions. In particular, the n value becomes negative for the OTf⁻-intercalation-induced redox, demonstrating that the transfer of OTf⁻ anions involves both the complete desolvation and removal of solvent molecules (i.e., acetonitrile) from the pores.

FIG. 10E is a graph showing the mass change of a Cr(TA)₂ film in the potential region of intercalation redox with BF₄_{^{−}}. FIG. 10F is a graph showing the mass change of a Cr(TA)₂ film in the potential region of intercalation redox with ClO₄_{^{−}}. FIG. 10G is a graph showing the mass change of a Cr(TA)₂ film in the potential region of intercalation redox with PF₆_{^{−}}. FIG. 10H is a graph showing the mass change of the Cr(TA)₂ nanoparticles in the potential region of intercalation redox with OTf⁻. In view of FIGS. 10E-10H, the EQCM experiments reveal that the mass-change hysteresis during anion intercalation (mass increase) and de-intercalation (mass decrease) broadens with the use of larger anions, demonstrating that mass transport dynamics become more sluggish with increasing anion size. Furthermore, FIG. 10I is a graph showing the scan-rate-dependent ΔE value for the intercalation redox feature of Cr(TA)₂ nanoparticle film in 0.1 M TBAOTf and 0.1 M TBABF₄, which demonstrates that such anion-size-dependent mass transport dynamics is further supported by the larger ΔE value of intercalation redox feature with increasing the anion size.

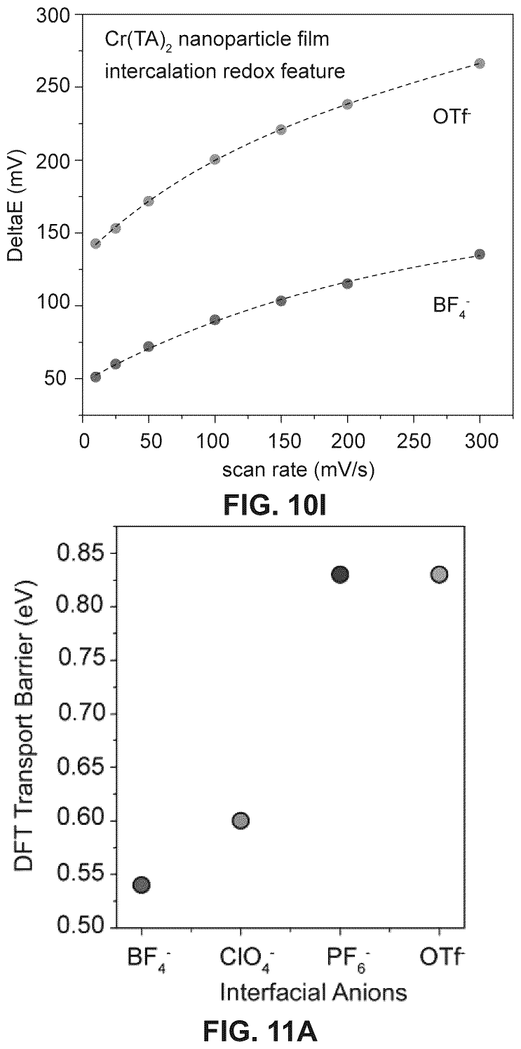

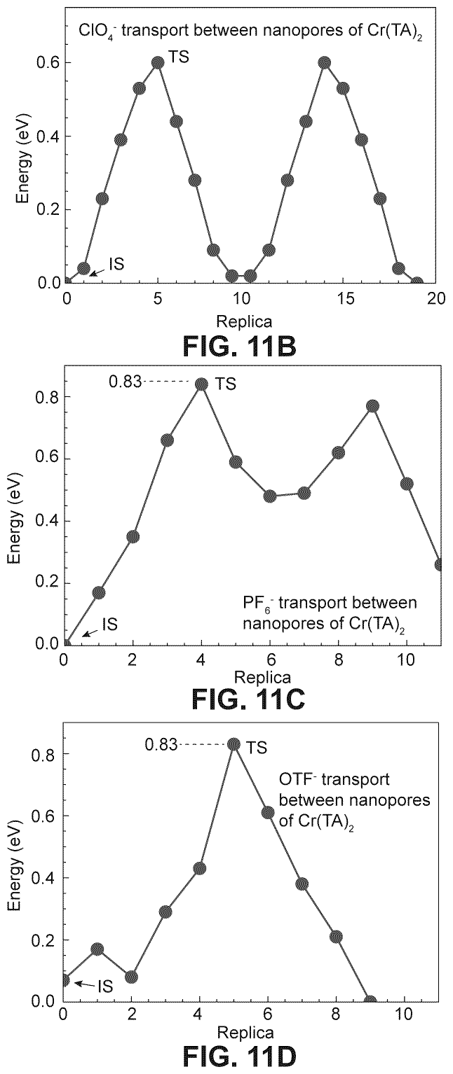

Additionally, DFT CI-NEB calculations reveal that the larger anions result in a higher transport energy barrier within Cr(TA)₂ nanopores. FIG. 11A is a graph showing the DFT analysis into transport barrier of BF₄_{^{−}}, ClO₄_{^{−}}, PF₆_{^{−}}, and OTf⁻. FIG. 11B is a graph showing the DFT calculations for determining the activation barrier of ClO₄_{^{−}} intercalation inside Cr(TA)₂ nanoconfined pores (“IS” refers to the initial state, “TS” refers to the transition state, and “FS” refers to the final state), wherein the activation barrier ca. 0.60 eV is the difference between IS and TS (the replica in the x-axis represents an intermediate image along the reaction path). FIG. 11C is a graph showing the DFT calculations for determining the activation barrier of PF₆_{^{−}} intercalation inside Cr(TA)₂ nanoconfined pores (“IS” refers to the initial state, “TS” refers to the transition state, and “FS” refers to the final state), wherein the activation barrier ca. 0.83 eV is the difference between IS and TS (the replica in the x-axis represents an intermediate image along the reaction path). FIG. 11D is a graph showing the DFT calculations for determining the activation barrier of OTf⁻ intercalation inside Cr(TA)₂ nanoconfined pores (“IS” refers to the initial state, “TS” refers to the transition state, and “FS” refers to the final state), wherein the activation barrier ca. 0.8 eV is the difference between IS and TS (the replica in the x-axis represents an intermediate image along the reaction path). In view of FIG. 11D, the mass transport barrier increases from ca. 0.54 eV for BF₄_{^{−}} to ca. 0.83 eV for the larger OTf⁻ anions.

These anion-dependent variations in solvation shell and transport energy barrier together demonstrate that the use of larger anions intensifies the nanoconfinement effect within the Cr(TA)₂ pores, gating the interfacial anion transfer and therefore thermodynamically and kinetically disfavoring the interior anion-coupled redox chemistry. The schematics shown in FIGS. 1C-1D depict the difference in these processes, where the more favorable redox-coupled intercalation of BF₄_{^{−}} involves a solvation shell, whereas the anodically shifted intercalation of OTf⁻ involves complete desolvation, greater solvent reorganization, and a larger redox entropy change. Further, the current density of ClO₄_{^{−}}-transfer-induced Cr redox peak exhibits greater symmetry compared to other anions with similar structure and size (e.g., BF₄_{^{−}}).

### Example 8

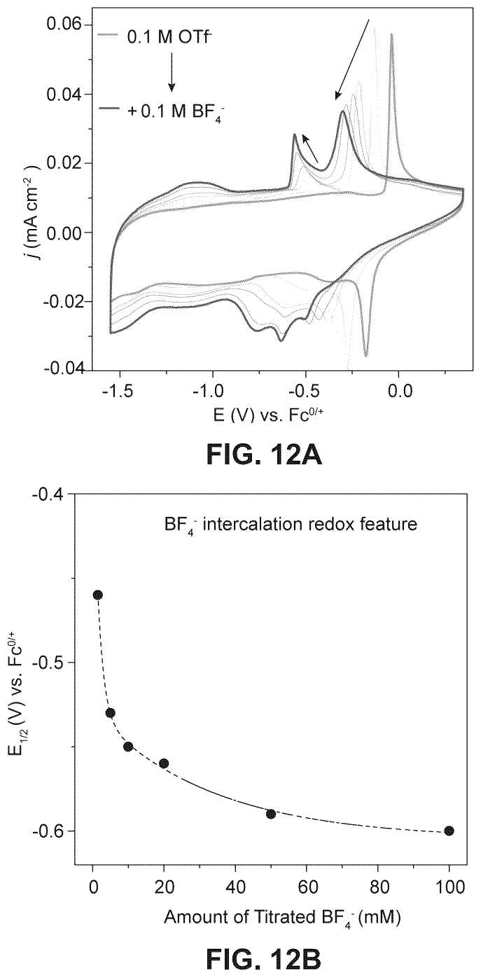

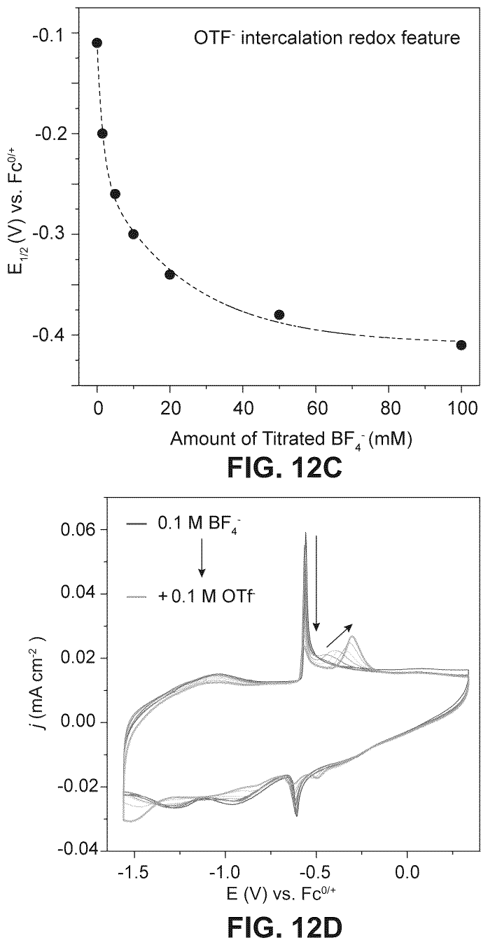

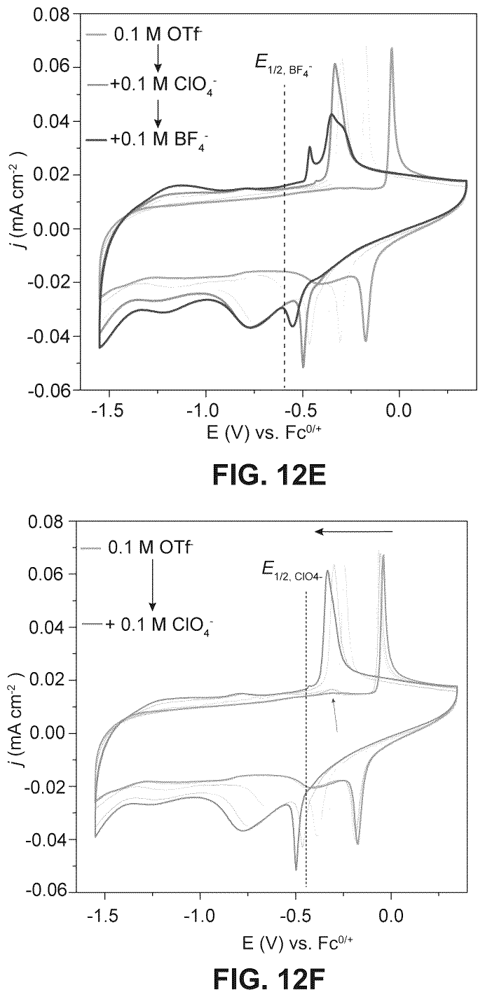

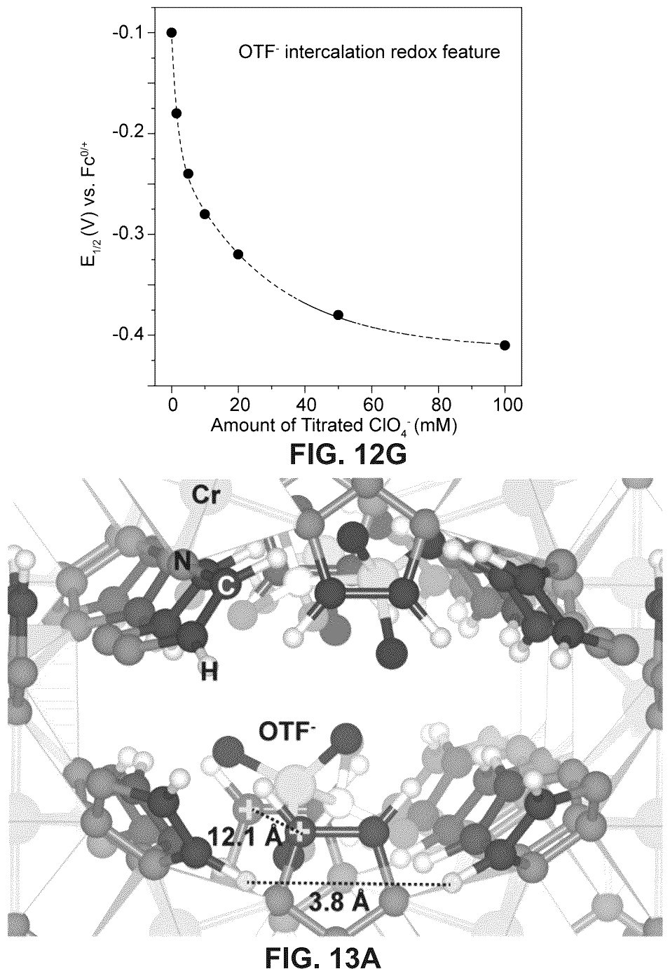

To investigate whether specific signals could be detected from mixtures of anions, small quantities of TBABF₄ (i.e., mM scale) were titrated into a 0.1-M TBAOTf acetonitrile solution containing a 25-nm Cr(TA)₂ nanoparticle film. FIG. 12A is a line graph showing the CV measurements of a Cr(TA)₂ nanoparticle film during titrating TBABF₄ into a 0.1-M TBAOTf acetonitrile electrolyte. FIG. 12B is a line graph showing the E_{1/2} of the BF₄_{^{−}}-intercalation-induced redox feature for Cr(TA)₂ film with different BF₄_{^{−}} titration amounts into a 0.1-M TBAOTf acetonitrile solution. FIG. 12C is a line graph showing the E_{1/2} of the OTf⁻ intercalation-induced redox feature for a Cr(TA)₂ film with different BF₄_{^{−}} titration amounts into a 0.1-M TBAOTf acetonitrile solution. FIG. 12D is a line graph showing the CV measurements of a Cr(TA)₂ nanoparticle film during titrating TBAOTf into a 0.1-M TBABF₄ acetonitrile electrolyte.

FIGS. 12A-12B demonstrate that the addition of BF₄_{^{−}} anions results in a new redox feature cathodically shifted from ca. −0.46 V vs Fc^{0/+} to ca. −0.6 V vs Fc^{0/+} as the concentration of BF₄_{^{−}} anions increases from 1.5 mM to 0.1 M. The consistency of this −0.6 V feature after titration of 0.1-M TBABF₄ with the E_{1/2} in pure TBABF₄, along with its BF₄_{^{−}}-concentration-dependent current density, demonstrates that the new redox feature originates from interfacial BF₄_{^{−}} transfer. The redox signature observed at ca. −0.1 V vs Fc^{0/+} in pure OTf⁻ shifts to −0.4 V vs Fc^{0/+} after the addition of 0.1-M BF₄_{^{−}} (see FIGS. 12A and 12C). Therefore, the presence of BF₄_{^{−}} promotes the OTf-intercalation redox chemistry within Cr(TA)₂ nanoparticles. As a control, we observed that the E_{1/2} position of the BF₄_{^{−}} intercalation redox feature at ca. −0.6 V vs Fc^{0/+} remains unchanged when titrating TBAOTf into a 0.1-M TBABF₄ solution (FIG. 12D). This result demonstrates that the initial presence of BF₄_{^{−}} determines the local pore environment and remains unchanged in the presence of OTf⁻ anions, leading to the OTf⁻-titration-independent E_{1/2} value for the BF₄_{^{−}} intercalation redox feature.

To explore the possibility of detecting mixtures with three anions, two subsequent titrations were performed. FIG. 12E shows the CV measurements of the Cr(TA)₂ nanoparticles during titrating both TBABF₄ and TBAClO₄ into a 0.1-M TBAOTf acetonitrile electrolyte. FIG. 12G is a line graph showing the CV measurements collected at a 10 mV/s scan rate of the Cr(TA)₂ nanoparticles during titrating TBAClO₄ into a 0.1-M TBAOTf acetonitrile electrolyte (the arrow indicates the new redox feature induced by the titration of ClO₄_{^{−}} anions). As shown in FIGS. 12E-12G, the presence of ClO₄_{^{−}} introduces a distinct redox feature and a cathodic shift to the OTf⁻ intercalation redox feature. At ClO₄_{^{−}} concentrations of 0.1 M, the ClO₄_{^{−}} and OTf⁻ redox intercalation peaks merge into a single broad feature with an E_{1/2} value of ca. −0.4 V vs Fc^{0/+}. These results demonstrate that the presence of ClO₄_{^{−}} and the structural changes it induces to the pore of the Cr(TA)₂ cause the redox intercalation of ClO₄_{^{−}} and OTf⁻ anions to become electrochemically similar. Moreover, titrating 0.1-M BF₄_{^{−}} anions, as a third component, into a 0.1-M TBAOTf and 0.1-M TBAClO₄ electrolyte solution induces another distinct redox feature at −0.5 V vs Fc^{0/+} (see FIG. 12E). The observed E_{1/2} value differs from the −0.6 V vs Fc^{0/+} feature observed for pure BF₄_{^{−}} solutions. Furthermore, the addition of BF₄_{^{−}} anions decreases the current density of the ClO₄_{^{−}}/OTf⁻-intercalation redox features and causes them to split into two distinct waves as can be seen in FIG. 12E. The cathodic shift of ClO₄_{^{−}} intercalation redox feature from −0.33 V vs Fc^{0/+} in a 0.1-M ClO₄_{^{−}} and 0.1-M OTf⁻ electrolyte solution to −0.35 V vs Fc^{0/+} after the additional titration of 0.1-M BF₄_{^{−}} anions indicates that the BF₄_{^{−}} intercalation alters how the Cr(TA)₂ facilitates ClO₄_{^{−}} intercalation over OTf⁻. Meanwhile, the E_{1/2} of the OTf⁻ intercalation redox remains unchanged before and after the addition of BF₄_{^{−}} anions.

Accordingly, this example demonstrates that the presence of one type of anion species influences the electrochemical potential of intercalation for another anion species.

### Example 9

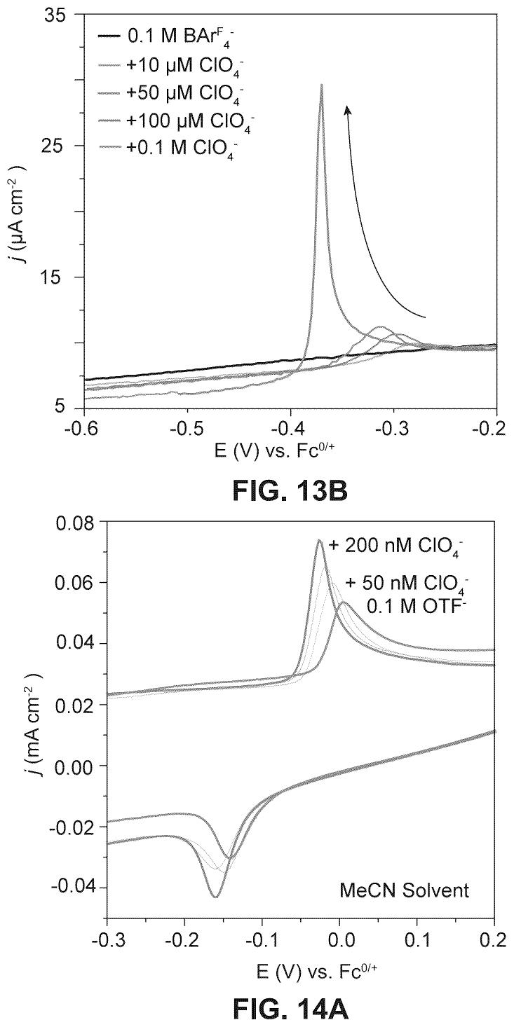

In this example, titrations were performed starting from [BAr^{F}₄]⁻ anions to investigate the redox intercalation for each anion. FIG. 13A shows the Cr(TA)₂ nanoparticle pore aperture of 3.8 Å, as defined by the H-H distance. FIG. 13B is a line graph showing the CV measurements collected at a 10 mV/s scan rate of the Cr(TA)₂ nanoparticle film during titrating TBAClO₄ into a 0.1-M NaBArF₄ acetonitrile electrolyte.

The voltametric response of 25-nm Cr(TA)₂ in 0.1-M BAr^{F}₄_{^{−}} anions showed no redox intercalation response, whereas a feature appears upon titration of 10-μM ClO₄_{^{−}} as exhibited in FIG. 13B. Increased concentrations cause a cathodic shift of the redox wave, demonstrating the intercalation energetics become more desirable. Moreover, the higher concentration detection limit in the presence of BAr^{F}₄_{^{−}} demonstrates that although this bulkier anion does not intercalate, it prevents intercalation of smaller anions.

Accordingly, this example demonstrates that electrochemical sensing of anions involves a turn-on mechanism sensitive to the specific energetics of anions to enter pores of the Cr(TA)₂ nanoparticles. Therefore, sub-nM detection limits with appropriate electrochemical equipment can measure low current densities.

### Example 10

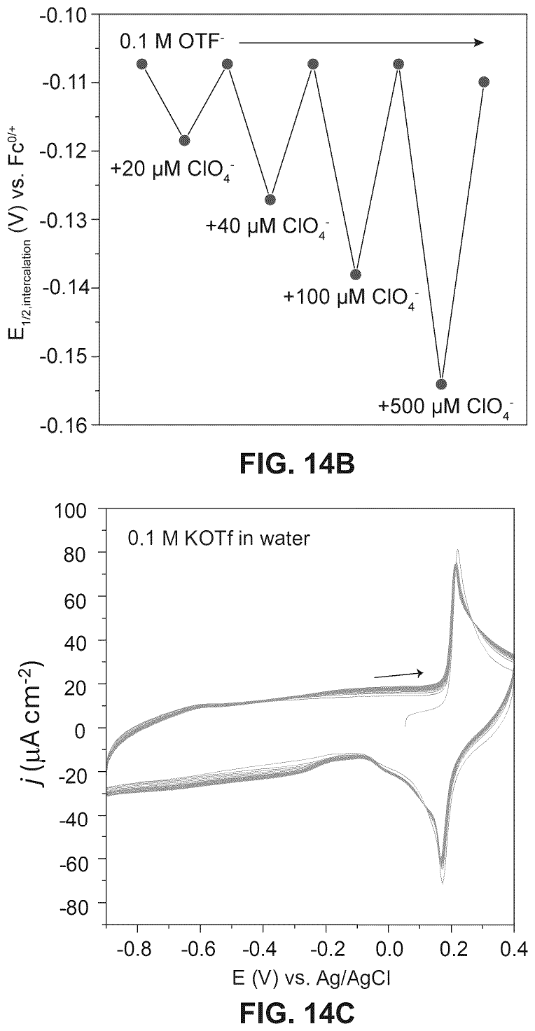

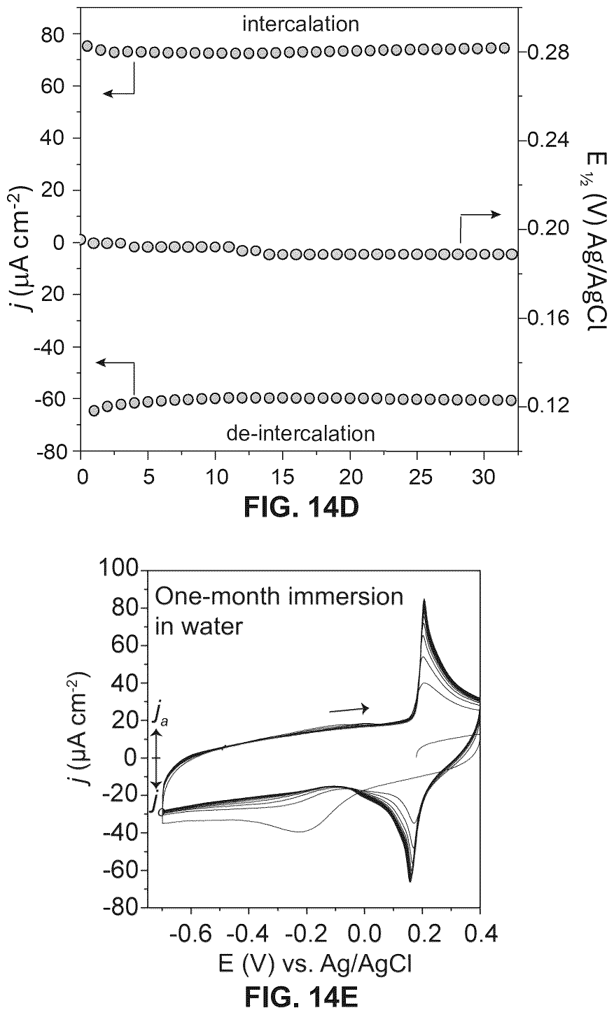

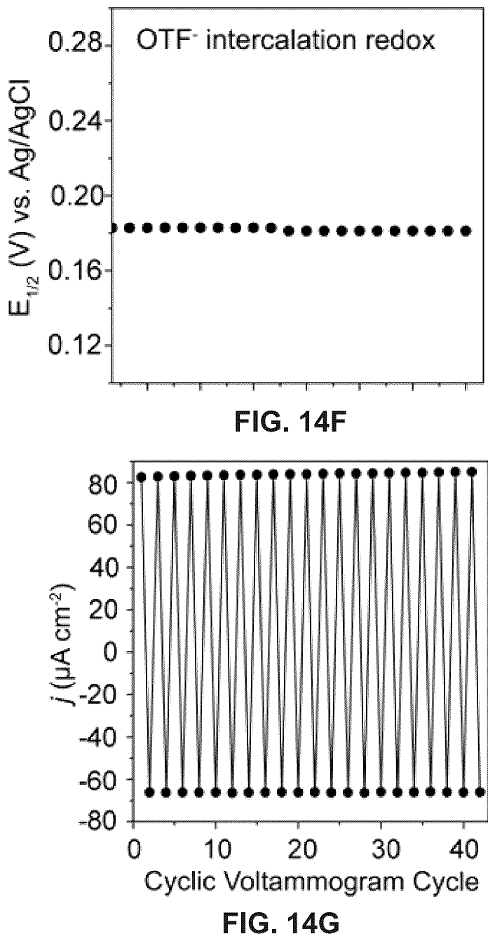

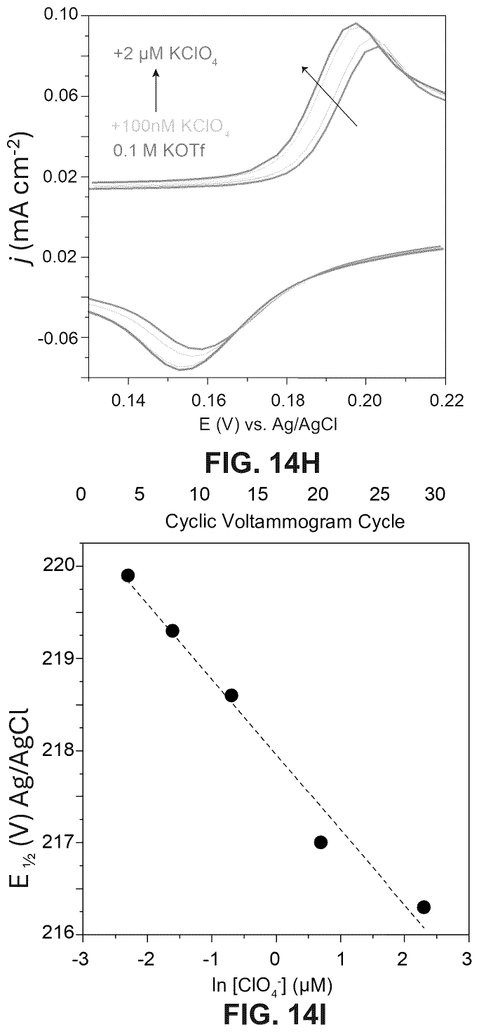

In this example, electrochemical anion sensing in organic solvents and aqueous media using the electrochemical analyte sensor comprising Cr(TA)₂ nanoparticles was investigated. FIG. 14A is a graph showing the CV measurements of a Cr(TA)₂ nanoparticle film measured by titrating different amounts of TBAClO₄ in the nM scale into 0.1-M TBAOTf acetonitrile solution. FIG. 14B is a graph showing the reusability test results for electrochemical ClO₄_{^{−}} sensing, wherein CV measurements were conducted in OTf⁻-intercalation-induced redox feature in Cr(TA)₂ film with different ClO₄_{^{−}} titration amounts into a 0.1-M TBAOTf acetonitrile solution; and after the addition of ClO₄_{^{−}}, the potential of −1.5 V vs Fc^{0/+} is applied for 20 minutes and E_{1/2} of intercalation redox feature of Cr(TA)₂ film is re-measured in clean 0.1-M TBAOTf acetonitrile solution.

In view of FIG. 14A, the intercalation redox feature of Cr(TA)₂ 0.1-M TBAOTf acetonitrile solution undergoes a cathodic shift in the presence of only 50-nM ClO₄_{^{−}}. This ClO₄_{^{−}}-induced shift to E_{1/2} can be reversed after poising the film at a potential of −1.5 V vs Fc^{0/+} for 20 minutes to de-intercalate ClO₄_{^{−}} anions from the pores as demonstrated in FIG. 14B. Therefore, FIGS. 14A-14B demonstrate that the electrochemical analyte sensor comprising Cr(TA)₂ nanoparticles is sensitive and reusable for electrochemical ClO₄_{^{−}} sensing.

FIG. 14C is a graph showing the structural stability test of electrochemical analyte sensor comprising Cr(TA)₂ nanoparticles in water via multiple CV measurement cycles. FIG. 14D is a graph showing the trace-dependent E_{1/2} of the intercalation redox feature, and trace-dependent current density of the intercalation and de-intercalation redox feature. FIG. 14E is a graph showing the multiple traces of CV measurement of Cr(TA)₂ nanoparticle in 0.1 M KOTf water solution at the scan rate of 10 mV/s. FIG. 14F is a graph showing the trace-dependent E_{1/2} of intercalation redox feature. FIG. 14G is a graph showing the trace-dependent current density of intercalation and de-intercalation redox feature. In addition to organic solvents, electrochemical analyte sensor comprising Cr(TA)₂ nanoparticles also exhibit structural stability in aqueous media, as evidenced by the stable E_{1/2} position of the intercalation redox peak and its repeatable current densities during the long-term CV cycles in a 0.1-M KOTf aqueous solution. Accordingly, the results shown in FIGS. 14C-14G demonstrate the practical applications of Cr(TA)₂ in the field of anion sensing in aqueous solutions.

FIG. 14H is a graph showing the CV measurements for sensing of ClO₄_{^{−}} anions using Cr(TA)₂ nanoparticle film in aqueous solution. In view of FIG. 14H, similar to the detection limit of ClO₄_{^{−}} in acetonitrile solvent, the ClO₄_{^{−}}-induced shift is detectable upon adding 100-nM ClO₄_{^{−}} to 0.1-M KOTf aqueous solutions.

FIG. 14I shows the cyclic voltammogram cycle of the variation of E_{1/2} for the intercalation redox feature during titrations of KClO₄ into a 0.1-M KOTf aqueous electrolyte solution, which demonstrates a linear relationship between E_{1/2} and ln[ClO₄_{^{−}}], indicating that the intercalation redox feature of Cr(TA)₂ follows a Nernstian response to the concentration of ClO₄_{^{−}} anions in aqueous solution. This relationship is consistent with the above titration experiments and demonstrates the active participation of ClO₄_{^{−}} anions in the Cr redox chemistry of Cr(TA)₂ nanocrystals within the nanoconfined pores.

Accordingly, this example demonstrates that anion-coupled redox intercalation of electrochemical analyte sensor comprising Cr(TA)₂ nanoparticles provide a platform for electrochemical anion sensors in biologically and environmentally relevant conditions such as, but not limited to, ClO₄_{^{−}}, a leading pollutant threatening environmental and food safety.

In view of the many possible aspects to which the principles of the present disclosure may be applied, it should be recognized that the illustrated aspects are only preferred examples and should not be taken as limiting the scope of the present disclosure. Rather, the scope is defined by the following claims. We therefore claim as our invention all that comes within the scope and spirit of these claims.

We claim:

1. A method, comprising:
exposing an electrochemical anion sensor to a sample, wherein the electrochemical anion sensor comprises an electrode functionalized with a conductive porous film comprising a plurality of crystalline metal organic framework (MOF) nanoparticles having a pore size ranging from greater than 4.5 Å to less than 10 Å; and
applying a potential to the electrode.

2. The method of claim 1, further comprising measuring a signal produced by one or more anions present in the sample to thereby detect the presence and/or identity of the one or more anions.

3. The method of claim 2, wherein the one or more anions independently have a diameter ranging from 1 Å to 10 Å.

4. The method of claim 2, wherein the one or more anions are independently selected from halide anions, perhalogenated anions, oxyanions, nitrile-containing anions, or any combination thereof.

5. The method of claim 4, wherein the one or more halide anions are selected from F⁻, Cl⁻, I⁻, Br⁻, or any combination thereof.

6. The method of claim 4, wherein the one or more perhalogenated anions are selected from BF₄_{^{−}}, PF₆_{^{−}}, OTf⁻, CF₃SO₃_{^{−}}, CF₃SO₂NH⁻, or any combination thereof.

7. The method of claim 4, wherein the one or more nitrile-containing anions are C₂N₃_{^{−}}.

8. The method of claim 4, wherein the one or more oxyanions comprise a halogen, sulfate, phosphate, or nitrate.

9. The method of claim 8, wherein the one or more oxyanions are ClO₄_{^{−}}.

10. The method of claim 2, wherein the potential is a varying potential and the signal is detected as an intercalation potential.

11. The method of claim 2, wherein the potential is a fixed potential and the signal is detected as a change in current.

12. The method of claim 2, wherein a detected concentration of the one or more anions in the sample ranges from 1 nanomolar to 1 molar.

13. The method of claim 2, wherein the one or more anions comprise a first anion species and a second ion species, and wherein the first anion species is different from the second anion species.

14. The method of claim 13, wherein the one or more anions further comprise a third anion species, and wherein the third anion species is different from the first anion species and the second anion species.

15. The method of claim 2, further comprising applying a negative voltage to de-intercalate the one or more anions from pores of the MOF nanoparticles.

16. The method of claim 1, wherein the MOF nanoparticles have a polydispersity index value ranging from a value greater than 0 to a value less than 0.4.

17. An electrochemical analyte sensor, comprising:
a working electrode functionalized with a plurality of crystalline metal-organic framework (MOF) nanoparticles having a pore size ranging from greater than 4.5 Å to less than 10 Å;
a counter electrode; and
a reference electrode.

18. The electrochemical analyte sensor of claim 17, further comprising a control unit comprising:
(i) a power component for applying an electrical potential to the working electrode; and/or
(ii) a measuring component for measuring a voltage and/or a current.

19. The electrochemical analyte sensor of claim 17, further comprising an electrolyte-containing solution comprising one or more cations, wherein the electrolyte-containing solution is an organic solution or an aqueous solution.

20. The electrochemical analyte sensor of claim 18, wherein (i) the power component is selected from a power supply, a voltage supply, a potentiostat, or any combination thereof; and wherein (ii) the measuring component is selected from a voltmeter, a potentiometer, an ammeter, a resistometer, or any combination thereof.

21. A method of using the electrochemical analyte sensor of claim 17, the method comprising:
exposing the electrochemical analyte sensor to a liquid sample; and
applying a varying potential between the working electrode and the counter electrode.

22. The method of claim 21, further comprising measuring an intercalation potential associated with intercalation of one or more anions with the Cr(1,2,3-triazolate)₂ MOF nanoparticles, wherein the one or more anions are selected from F⁻, I⁻, Cl⁻, or B⁻, BF₄_{^{−}}, ClO₄_{^{−}}, PF₆_{^{−}}, OTf⁻, C₂N₃_{^{−}}, CF₃SO₂NH⁻, or any combination thereof.
